(19) United States
(12) Patent Application Publication
(10) Pub. No.: US 2013/0100511 A1
(43) Pub. Date: Apr. 25, 2013

(54) DISPLAY DEVICE

(71) Applicants: Kakuya Yamamoto, Hyogo (JP); Kenichi Kasazumi, Osaka (JP); Keiji Sugiyama, Kyoto (JP)

(72) Inventors: Kakuya Yamamoto, Hyogo (JP); Kenichi Kasazumi, Osaka (JP); Keiji Sugiyama, Kyoto (JP)

(21) Appl. No.: 13/699,385

(22) PCT Filed: Mar. 14, 2012
(86) PCT No.: PCT/JP2012/001800

§ 371 Date: Nov. 21, 2012

(30) Foreign Application Priority Data
Mar. 25, 2011 (JP) 2011-067243

(51) Int. Cl. G03H 1/08

(52) U.S. Cl. 359/9

(57) ABSTRACT

A display device (1) includes a light source (101) which outputs laser light, an illumination optical system (102) which emits the laser light as illumination light, a spatial modulation element (103) which diffracts the illumination light by displaying a diffraction pattern, and a wearing section (111) for wearing on a user's head. A positional relationship between the spatial modulation element (103) and an expected eye position (191a), which is expected to be a position of an eye (190) of the user, is fixed in a state where the wearing section (111) is worn on the user's head. The spatial modulation element (103) displays, as the diffraction pattern, a diffraction pattern by which a fictive image is displayed to the user due to diffracted light, which has been diffracted by the diffraction pattern, reaching the expected eye position (191a).

### TECHNICAL FIELD

The present invention relates to a head-mounted type display device which displays information by diffracting laser light by a diffraction pattern based on a computer generated hologram.

### BACKGROUND ART

A head-mounted display (hereinafter called “HMD”) is a device which displays information to a user while being mounted on the user's head. Desirably, an HMD is compact and lightweight, from the viewpoint of wearability, but has a large screen for high image quality, from the viewpoint of display characteristics. Conventionally, in an HMD, an enlarged fictive image is displayed to the user by optically enlarging an image displayed on a small liquid crystal panel, or the like, by means of a convex lens or free-form surface prism, or the like (hereinafter, called “optical enlarging method”). For example, the “image display device” according to Patent Document 1 is one HMD based on an optical enlarging method.

Furthermore, in a display device which uses a computer generated hologram (hereinafter, “CGH”), a wave front of display light from a fictive image position is reproduced and a fictive image is displayed to a user, by obtaining a diffraction pattern by means of a computer using an image to be displayed as input data, and displaying this diffraction pattern on a phase modulation type liquid crystal panel or the like, and then irradiating and diffracting laser light on this liquid crystal panel. A characteristic feature of the CGH method is that a three-dimensional stereoscopic image can be displayed at a position in front of or behind the liquid crystal panel. For instance, one example of an apparatus for achieving a three-dimensional stereoscopic display by a CGH method is “a three-dimensional scene holographic reconstruction apparatus” according to Patent Document 2. Furthermore, although it does not involve a CGH method, there is also a related art example which displays a three-dimensional stereoscopic image to a user by a diffraction pattern (see Patent Document 3).

However, in the conventional optical enlarging method described above, in order to make the main body of the device compact, a compact liquid crystal panel is arranged close to the user's eye, while a virtual screen which is displayed to the user is displayed larger than the liquid crystal panel size and at a further distance than the liquid crystal panel, but since the enlarging optical system becomes large in size, then it has been difficult to achieve both a compact size of the display device and a distant large-screen display.

Furthermore, with the conventional CGH described above, the diffraction angle can be made larger, as the dot pitch of the liquid crystal panel which displays the diffraction pattern becomes finer. Thus, a liquid crystal panel having a fine dot pitch is used. As a result, the size of the liquid crystal panel becomes relatively small and hence a large screen is difficult to achieve.

In Patent Document 2, a large screen size (a wide angle of view) is achieved by irradiating parallel laser light, which is irradiated onto a liquid crystal panel, from a plurality of angles, by providing a plurality of light sources. Furthermore, in Patent Document 3, a large screen size is achieved by a scanning method which alters, over time, an incidence angle of parallel laser light which is irradiated onto a liquid crystal panel. However, with either of these methods, a plurality of light sources and a plurality of scanning means are required in order to alter the incidence angle of the parallel laser light and this is a problem for making the main body of the device compact in size.

Patent Document 1: Japanese Patent Application Publication No. H08-240773

Patent Document 2: Japanese Translation of PCT Application No. 2008-541145

Patent Document 3: Japanese Patent Application Publication No. H06-202575

### SUMMARY OF INVENTION

The present invention resolves the aforementioned conventional problems, an object thereof being to provide a display device which achieves both a compact size of the main body of the device and large screen size (a wide angle of view) by a distant display of a fictive image which is displayed to a user.

The display device according to one aspect of the present invention includes: a light source which outputs laser light; an illumination optical system which emits the laser light as illumination light; a spatial modulation element which diffracts the illumination light by displaying a diffraction pattern; and a wearing section for wearing on a user's head, wherein a positional relationship between the spatial modulation element and an expected eye position, which is expected to be a position of an eye of the user, is fixed in a state where the wearing section is worn on the user's head, and the spatial modulation element displays, as the diffraction pattern, a diffraction pattern by which a fictive image is displayed to the user due to diffracted light, which has been diffracted by the diffraction pattern, reaching the expected eye position.

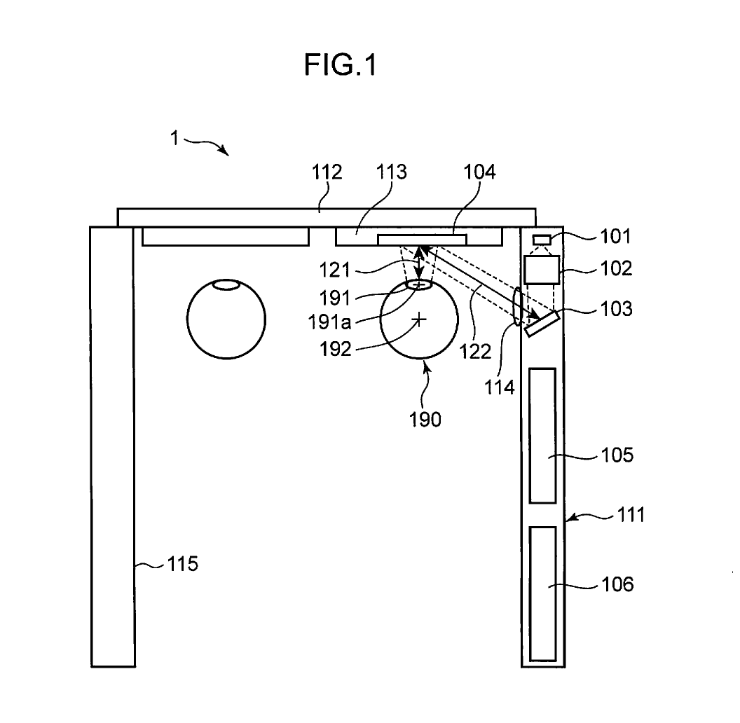

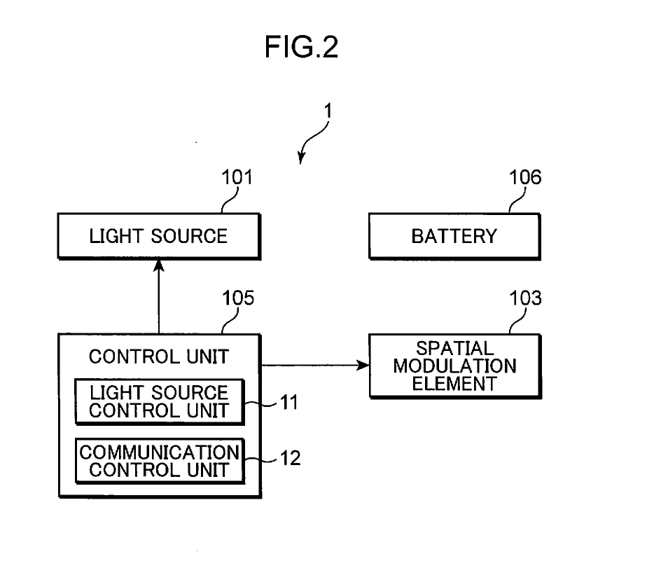

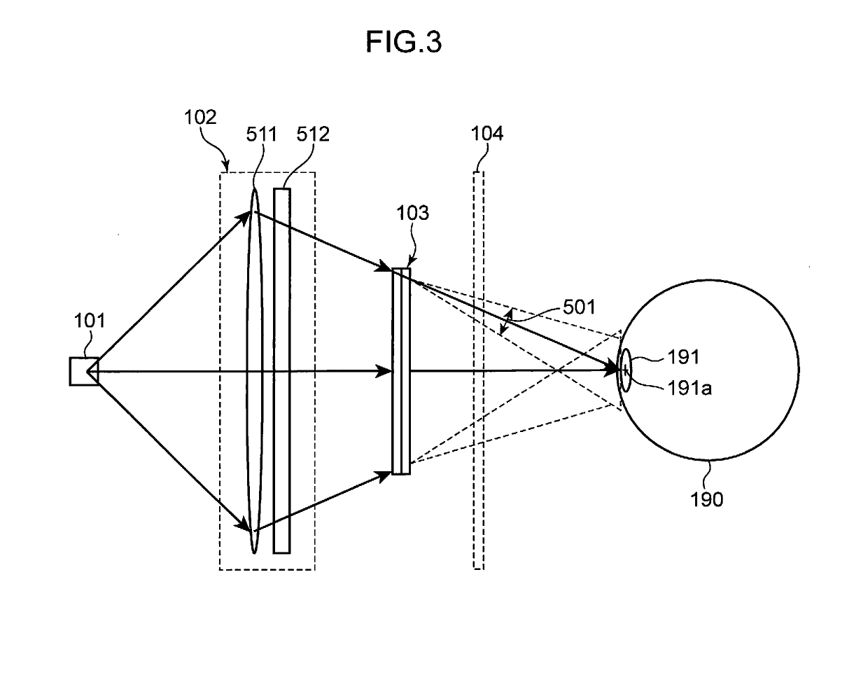

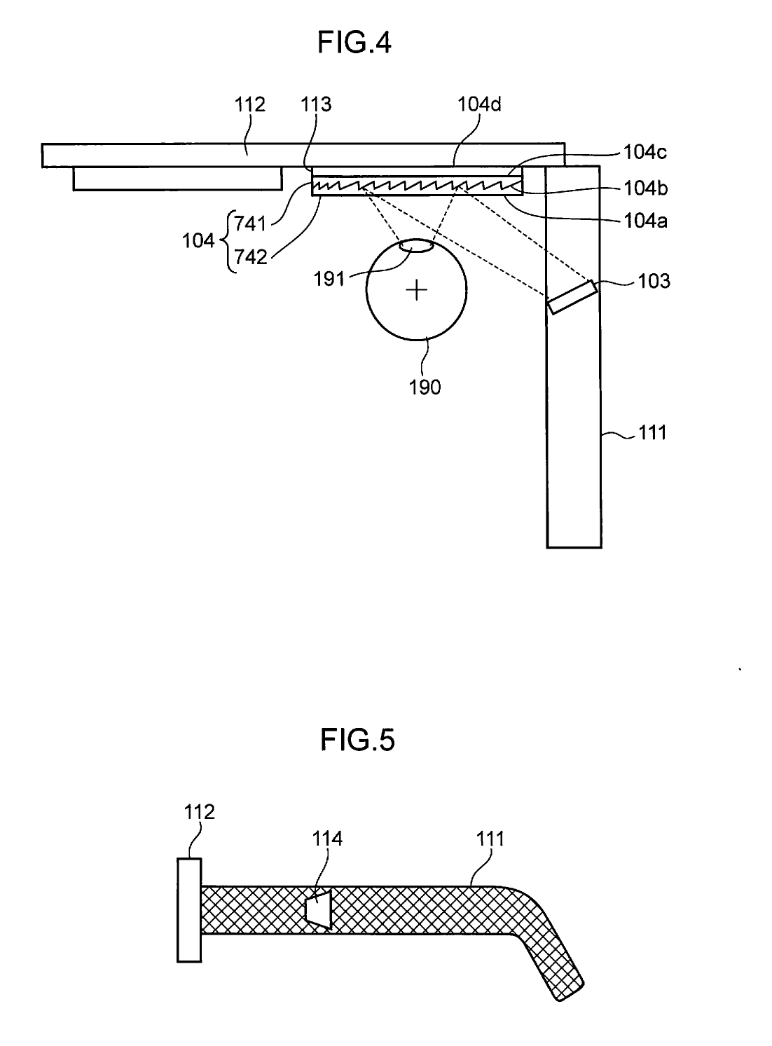

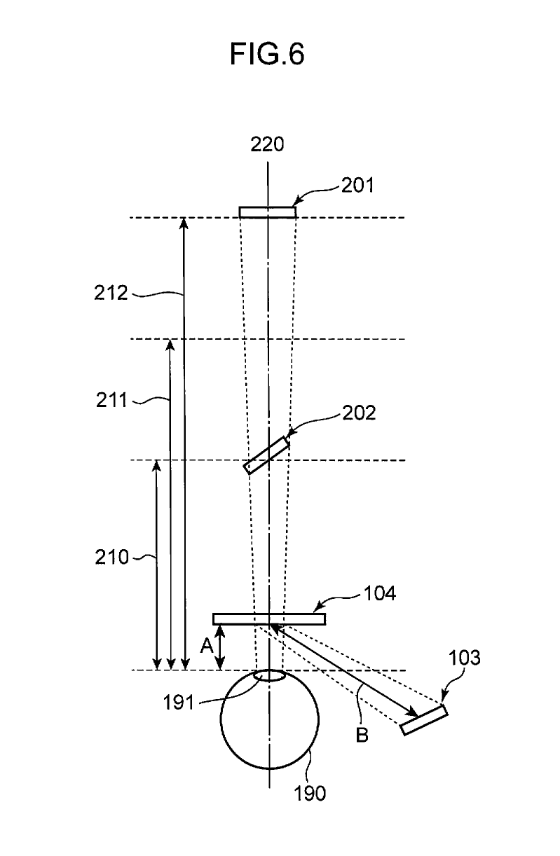

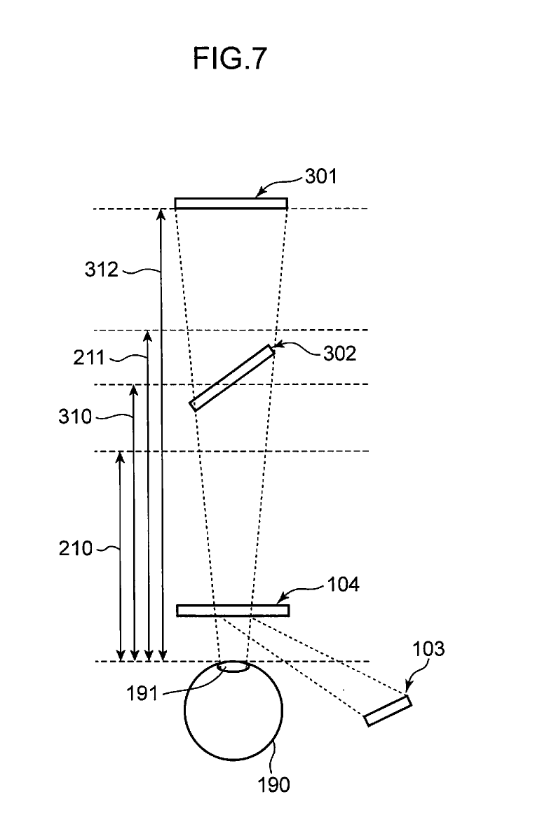

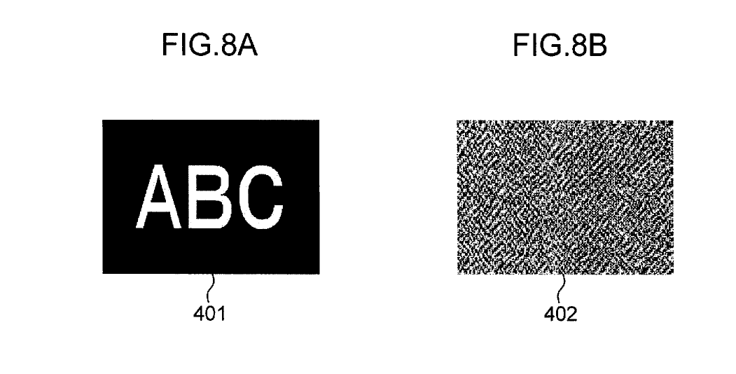

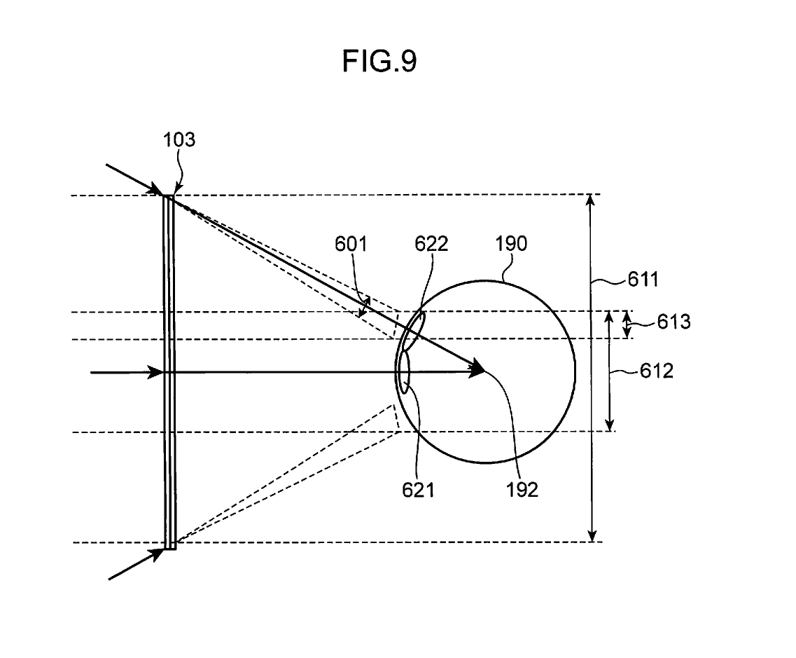

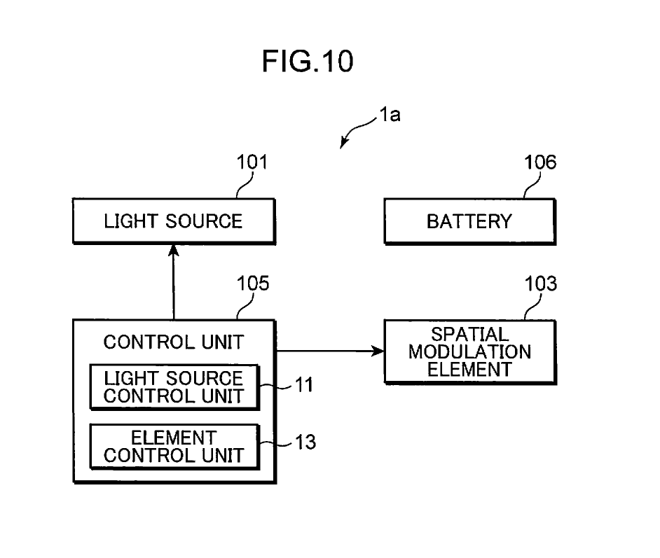

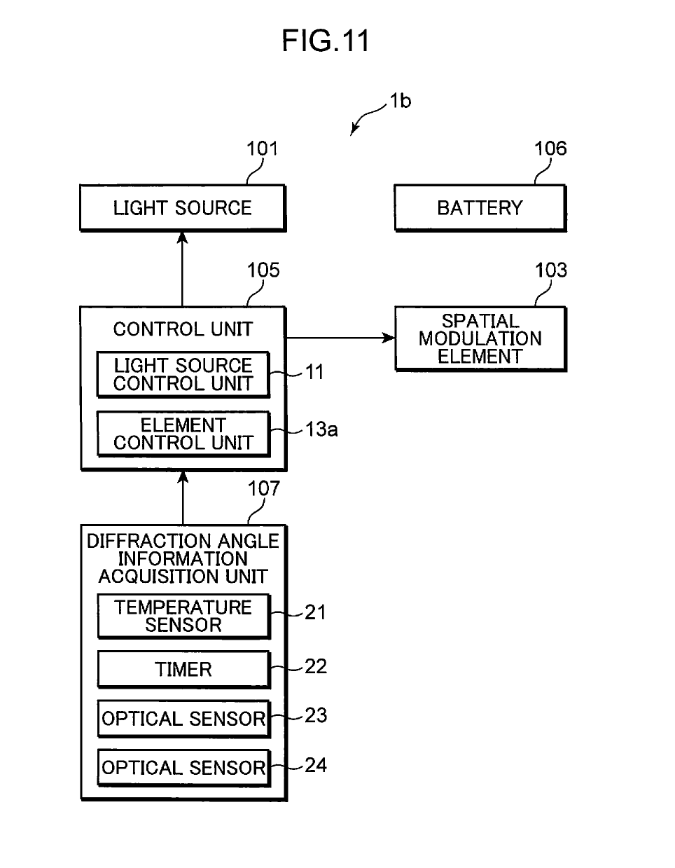

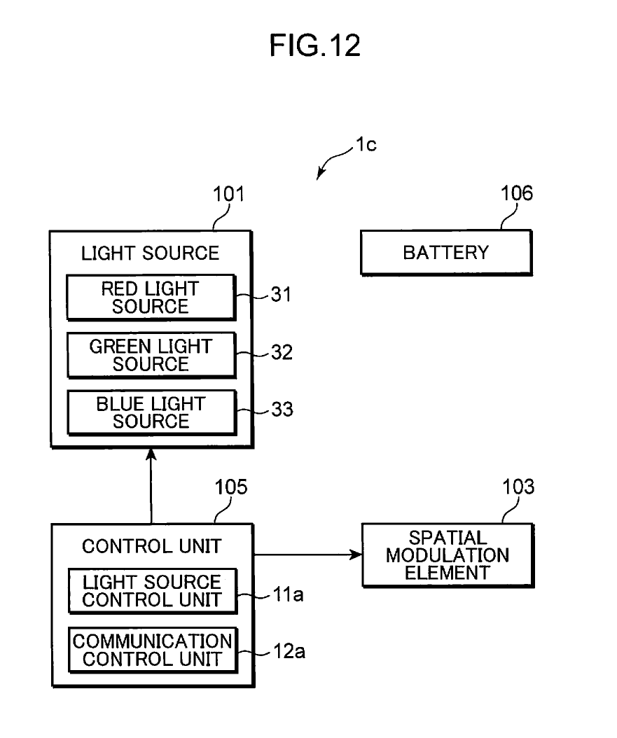

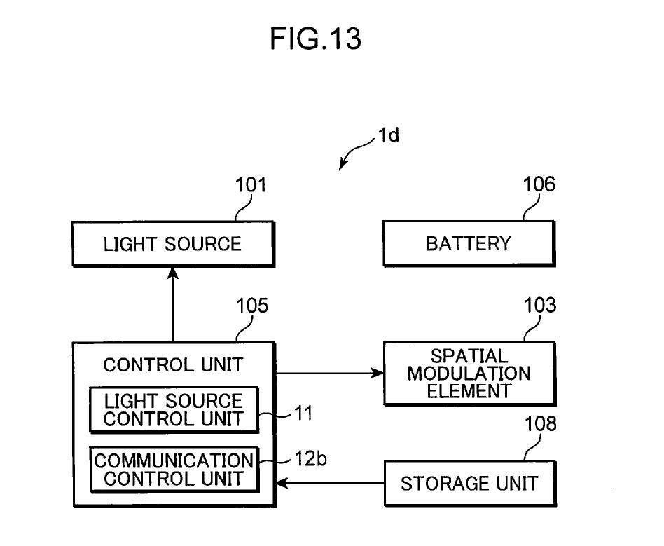

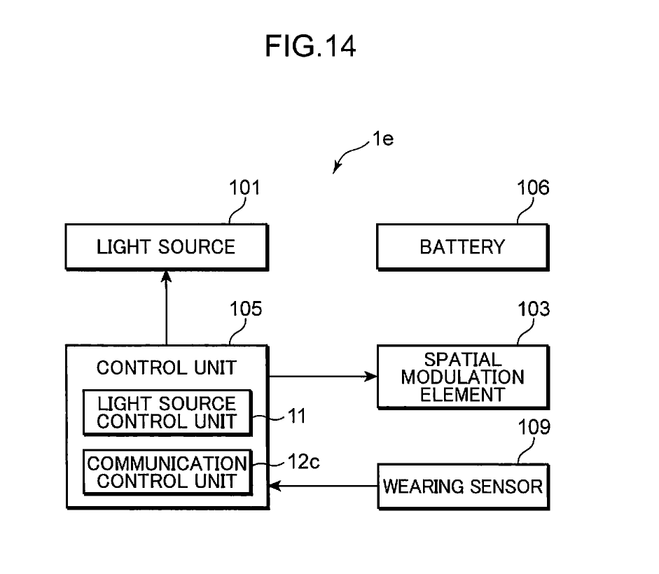

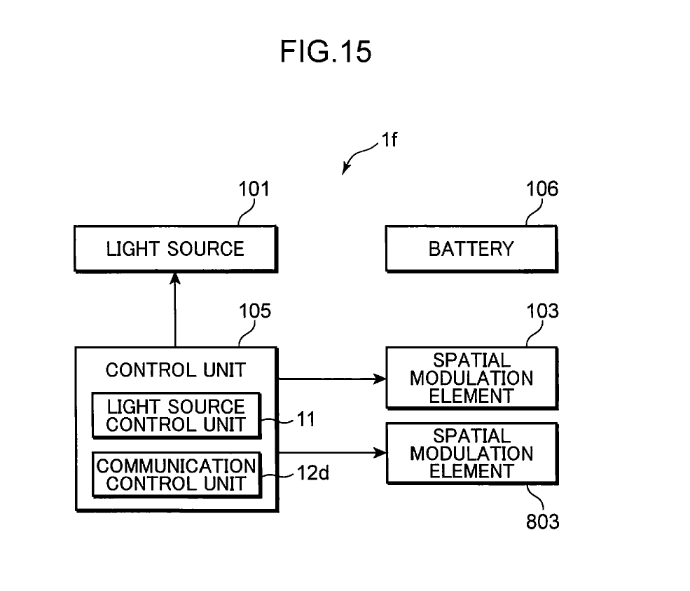

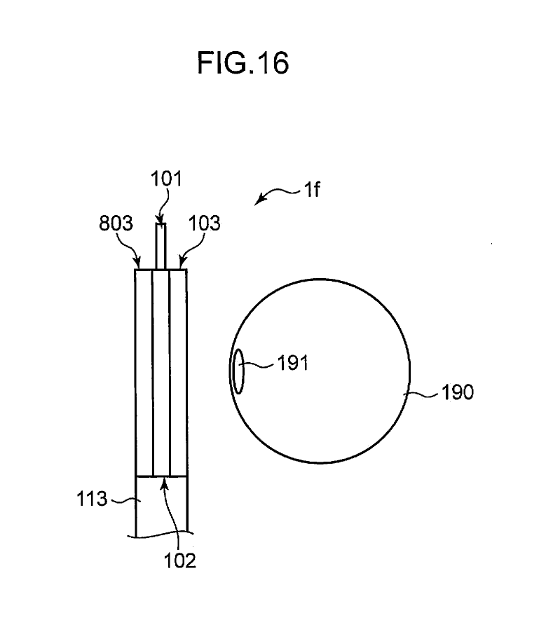

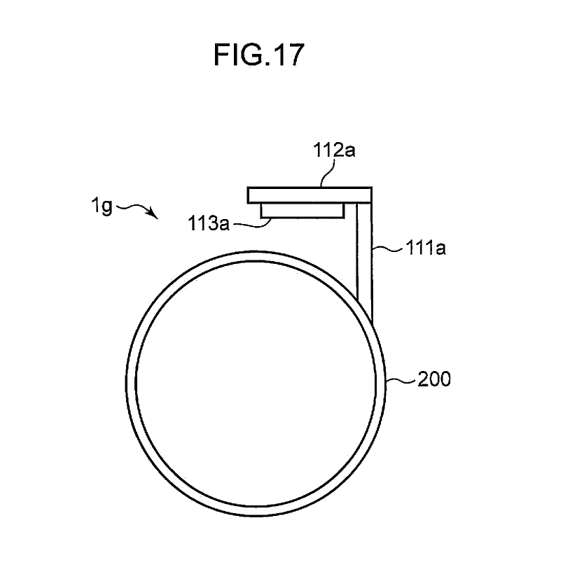

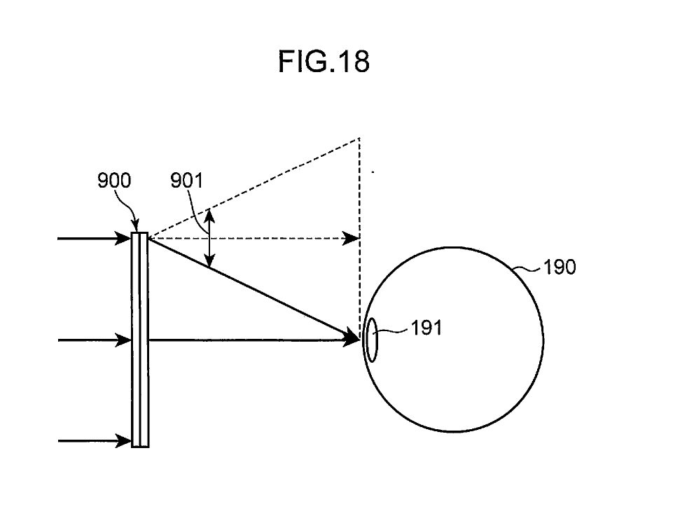

### BRIEF DESCRIPTION OF DRAWINGS

[FIG. 1] FIG. 1 is a diagram showing a schematic view of the composition of a head-mounted type display device according to a first embodiment of the present invention.

[FIG. 2] FIG. 2 is a block diagram showing an electrical composition of the display device 1 shown in FIG. 1.

[FIG. 3] FIG. 3 is a diagram showing an illumination optical system which illuminates a spatial modulation element of the display device shown in FIG. 1.

[FIG. 4] FIG. 4 is a diagram showing a composition of a reflecting mirror of the display device shown in FIG. 1.

[FIG. 5] FIG. 5 is a diagram showing an emission aperture of the display device shown in FIG. 1.

[FIG. 6] FIG. 6 is a diagram illustrating a positional relationship between an eye, a reflecting mirror, a spatial modulation element and a fictive image, and the like.

[FIG. 7] FIG. 7 is a diagram illustrating a positional relationship between an eye, a reflecting mirror, a spatial modulation element and a fictive image, and the like.

[FIG. 8] FIG. 8A is a diagram showing a fictive image and FIG. 8B is a diagram showing a diffraction pattern which achieves the fictive image shown in FIG. 8A.

[FIG. 9] FIG. 9 is a diagram showing an illumination optical system different from that shown in FIG. 3.

[FIG. 10] FIG. 10 is a block diagram showing an electrical composition of a display device according to a second embodiment of the present invention.

[FIG. 11] FIG. 11 is a block diagram showing an electrical composition of a display device according to a third embodiment of the present invention.

[FIG. 12] FIG. 12 is a block diagram showing an electrical composition of a display device according to a fourth embodiment of the present invention.

[FIG. 13] FIG. 13 is a block diagram showing an electrical composition of a display device according to a fifth embodiment of the present invention.

[FIG. 14] FIG. 14 is a block diagram showing an electrical composition of a display device according to a sixth embodiment of the present invention.

[FIG. 15] FIG. 15 is a block diagram showing an electrical composition of a display device according to a seventh embodiment of the present invention.

[FIG. 16] FIG. 16 is a diagram showing a composition of the principal part of a display device according to the seventh embodiment of the present invention.

[FIG. 17] FIG. 17 is a diagram showing a schematic view of one example of a display device having a form different to glasses.

[FIG. 18] FIG. 18 is a diagram showing an illumination optical system in a conventional display device.

### DESCRIPTION OF EMBODIMENTS

Below, an embodiment of the present invention is described with reference to the drawings.

### First Embodiment

FIG. 1 is a diagram showing a schematic view of the composition of a display device 1 according to a first embodiment of the present invention. FIG. 2 is a block diagram showing an electrical composition of the display device 1 shown in FIG. 1. FIG. 3 is a diagram showing an illumination optical system which illuminates a spatial modulation element of the display device 1 shown in FIG. 1. FIG. 4 is a diagram showing a composition of a reflecting mirror of the display device 1 shown in FIG. 1. FIG. 5 is a diagram showing an emission aperture of the display device 1 shown in FIG. 1. The display device 1 according to the first embodiment has the form of glasses, and FIG. 1 is a view observed from above.

In FIG. 1, the light source 101 is a laser light source which outputs laser light. In FIG. 1, a semiconductor laser (laser diode) which outputs laser light of a green wavelength is used as the light source. The laser light may be red or blue monochrome light, or a color display which combines the three colors of red, green and blue. Furthermore, it is also possible to use a laser other than a semiconductor laser, or to use a combination of a semiconductor laser and another laser. It is also possible to use a combination of an infrared semiconductor laser and a second harmonic generator (SHG) element which converts the infrared light into green light. The light source 101 outputs laser light having a spectral width of not less than 0.1 nm, for instance.

The illumination optical system 102 emits illumination light obtained by changing a wave front shape and an intensity distribution of laser light from the light source 101. In the first embodiment, as shown in FIG. 3, the illumination optical system 102 includes a convex lens 511 which converts diffused laser light into converging light, and a darkening filter (ND filter) 512 which attenuates the intensity of the laser light. The wave front shape of the illumination light may be changed by means of a lens or a mirror, or an element which is capable of changing the shape dynamically, such as a liquid crystal lens. Furthermore, it is also possible to include an optical system which changes the intensity distribution. A filter for eliminating unwanted illumination light may also be included. The illumination optical system 102 is described further below.

The spatial modulation element 103 diffracts the illumination light from the illumination optical system 102 by displaying a diffraction pattern. In the first embodiment, a phase modulation type of reflective liquid crystal panel is used as the spatial modulation element 103. The spatial modulation element 103 is not limited to a liquid crystal panel and may be another display element provided that it is capable of diffracting illumination light by displaying a diffraction pattern.

The reflecting mirror 104 reflects the diffracted light from the spatial modulation element 103 towards a user's eye 190. In the first embodiment, a Fresnel lens 742 is used as the reflecting mirror 104, as shown in FIG. 4. The reflecting mirror 104 is made into a semi-transmissive Fresnel mirror by vapor depositing a thin metal film onto a Fresnel lens 742. The Fresnel lens 742 is bonded by adhesive 741 to a lens section 113 of a front section 112.

In FIG. 4, the Fresnel lens 742, the adhesive 741 and the lens section 113 are arranged in sequence from the side of the eye 190 (the lower side in FIG. 4) to the opposite side (the upper side in FIG. 4). The Fresnel lens 742 and the lens section 113 bonded by the adhesive 741 have the following interfaces, in sequence from the side of the eye 190 to the opposite side: a surface 104a on the side of the eye 190, a Fresnel lens surface 104b, a bonding surface 104c and a surface 104d on the opposite side. The diffracted light from the spatial modulation element 103 is reflected by the Fresnel lens surface 104b and directed towards the user's pupil 191. The closer the refractive index of the Fresnel lens 742 and the refractive index of the layer of the adhesive 741, the greater the extent to which distortion of the scene outside that is transmitted can be reduced. For the Fresnel lens 742, it is possible to use a prism sheet having an optical magnification of 1, or a Fresnel lens having an optical magnification.

It is also possible to form an HMD in which the user views a liquid crystal panel directly, without using a reflecting mirror 104. The reflecting mirror may be a lens type or may be realized by a diffraction grating, such as a hologram. Furthermore, the reflecting mirror 104 according to the first embodiment reflects the display light while also transmitting a scene outside, but a composition which does not transmit the scene outside is also possible. Moreover, in this embodiment, a reflecting mirror 104 is arranged on a surface of the lens section 113 of the front section 112, but it is also possible to arrange a reflecting mirror 104 inside the lens section 113.

The eye 190 depicts an eye which is located at an expected eye position in the display device 1. In the first embodiment, the expected eye position is a pupil center 191 a of a pupil 191 of an eye 190 when a user is wearing the display device 1. The expected eye position may be displaced to some extent from the pupil center 191a. The diffracted light which is reflected by the reflecting mirror 104 is focused as an image on the retina via the pupil 191 of the eye 190 which is situated at the expected eye position. Consequently, an image is displayed to the user. In other words, the user is able to view an image. The eyeball center 192 in FIG. 1 is a center position of the eye 190 and a center of rotation of the eye 190. When the user is wearing a display device 1 (in other words, when a temple section 111 is hooked on the user's ear), the positional relationship between the spatial modulation element 103 and the expected eye position is fixed. An allowable error may be provided in the expected eye position, and a function for adjusting the expected eye position may be provided, taking account of individual differences in the position of the eye 190 with respect to the head, depending on the user, and displacement of the wearing position of the display device 1.

The control unit 105 includes a light source control unit 11 and a communication control unit 12. The light source control unit 11 controls driving of the light source 101, turns on and off the light source 101, and adjusts an intensity of the laser light output by the light source 101 so that an appropriate amount of light is incident on the eye 190. The communication control unit 12 has a radio communication function and acquires a diffraction pattern which is transmitted from an external device. The communication control unit 12 controls the spatial modulation element 103 and causes the acquired diffraction pattern to be displayed on the spatial modulation element 103 (which is a liquid crystal panel in the first embodiment). Moreover, the communication control unit 12 may make modifications to the diffraction pattern. Furthermore, the control unit 105 may control a battery 106 or may control the illumination optical system 102 or the reflecting mirror 104, if these are controllable.

The battery 106 supplies electric power to each part of the display device 1, such as the control unit 105, the spatial modulation element 103, and the like. The battery 106 in FIG. 1 is rechargeable and is recharged when the user is not wearing the display device 1. The battery 106 is arranged close to a rear end of an ear side of the temple section 111, whereby the overall weight balance is close to the ear, thus providing a beneficial effect in reducing slipping of the front section 112. The battery 106 does not have to be rechargeable, and power supply may be implemented while the display device 1 is being used. Furthermore, power may be supplied from an external source, rather than providing a battery 106 in the display device 1. Moreover, the display device 1 may also have a member having a power generating function, instead of the battery 106.

Here, the illumination optical system 102 will be described further with reference to FIG. 3. The illumination optical system 102 includes the convex lens 511 and the darkening filter 512, as described above. As shown in FIG. 3, the illumination optical system 102 causes the laser light output from the light source 101 to converge on the pupil center 191a of the pupil 191 of the eye 190, by the convex lens 511. The darkening filter 512 reduces the intensity of the laser light so as to assume an intensity which is suited to viewing by the eye 190. The illumination light emitted from the illumination optical system 102 is diffracted by the diffraction pattern displayed on the spatial modulation element 103. In this embodiment, the spatial modulation element 103 is a reflective type of element, but is depicted as a transmissive element in FIG. 3 in order to simplify the drawing. Moreover, in this embodiment, as shown in FIG. 1, the spatial modulation element 103 is arranged obliquely with respect to the optical axis of the illumination optical system 102, but is depicted as being arranged perpendicularly with respect to the optical axis in FIG. 3, in order to simplify the drawing.

FIG. 18 is a diagram showing an illumination optical system in the example described in the Background Art (Patent Document 2 and Patent Document 3). In FIG. 18, parallel illumination light is diffracted by a spatial modulation element 900, and arrives at the pupil 191 of the eye 190 of the user. A diffraction angle 901 is required in order to diffract the light in the vicinity of an end of the spatial modulation element 900 towards the pupil 191, as shown in FIG. 18.

On the other hand, in the present embodiment, a diffraction angle 501 is sufficient as a diffraction angle in the vicinity of the end of the spatial modulation element 103, as shown in FIG. 3. In the illumination optical system 102 according to this embodiment, with the illumination light being light that converges on the center of the pupil 191, the diffraction angle 501 may be smaller than the diffraction angle 901 (FIG. 18).

In this embodiment, the required diffraction angle can be made smaller than the case shown in FIG. 18, and the dot pitch of the spatial modulation element 103 which displays the diffraction pattern may be larger than that of the spatial modulation element 900 shown in FIG. 18. Therefore, since a spatial modulation element, which is larger than a conventional spatial modulation element 900 of the same pixel number as the former, may be used, it is possible to achieve a large screen size. Alternatively, even if using a spatial modulation element of the same size as a conventional spatial modulation element 900, it is still possible to achieve a large screen size by increasing the optical magnification of the reflecting mirror 104.

The beneficial effects of being able to reduce the required diffraction angle by illumination with converging light in this way become greater, the larger the size of the spatial modulation element 103 compared to the size of the pupil 191. Furthermore, in a case where the spatial modulation element 103 is optically enlarged by a reflecting mirror 104 or the like, the above beneficial effects become greater, as the size of a virtual image of the spatial modulation element 103 becomes larger compared to the size of the pupil 191. Illumination of converging light onto the eye 190 is especially effective in a display device in which the positional relationship between the spatial modulation element 103 and the eye 190 is substantially fixed, as in the display device 1. If the positional relationship between the spatial modulation element 103 and the eye 190 is not fixed, then a separate mechanism for changing the center of convergence is required.

Returning to FIG. 1, the display device 1 which is in the form of glasses includes temple sections 111 which are head side sections, and a front section 112 located in front of the user's eyes. Inside the temple section 111, a void is formed, and the light source 101, the illumination optical system 102, the spatial modulation element 103, the control unit 105 and the battery 106 are arranged inside the void. An emission aperture 114 is provided in the temple section 111, so that diffracted light from the spatial modulation element 103 is emitted onto the reflecting mirror 104.

As shown in FIG. 5, the periphery of the emission aperture 114 is painted black, for instance, and the peripheral edges of the spatial modulation element 103 which is arranged in the temple section 111 are light-shielded. Consequently, unwanted diffracted light which is generated due to light other than the illumination light from the illumination optical system 102 being incident on the spatial modulation element 103 is prevented from arriving at the user's eye 190.

Furthermore, since the diffraction by the spatial modulation element 103 is performed inside the temple section 111 rather than the lens section 113, a beneficial effect is obtained in that countermeasures against unwanted diffracted light in the lens section 113 are not required. Since countermeasures against unwanted diffracted light are simplified, then a beneficial effect is obtained in that a display device 1 which has little unwanted diffracted light can be achieved, even in circumstances where unwanted diffracted light is generally liable to occur, such as outdoors or at night time. Even when the display device 1 is not displaying a fictive image and is used simply as glasses, a beneficial effect is obtained in that a state of little unwanted light can be achieved.

As shown in FIG. 5, the shape of the emission aperture 114 is a trapezoid shape and the vertical edge on the ear side (the right-hand side in FIG. 5) is longer than the vertical edge on the front side (the left-hand side in FIG. 5). Therefore, a beneficial effect is obtained in aligning the heights of the left and right-hand sides of the fictive image, by making the light incident obliquely on the reflecting mirror 104 and reflecting the light towards the eye 190.

The shape of the emission aperture 114 is not limited to a trapezoid shape, and may also be a circular shape, elliptical shape, a quadrilateral shape such as a rectangular shape, or another polygonal shape, or a free form surface. It is also possible to provide a hole in the emission aperture 114. When a hole is provided in the emission aperture 114, beneficial effects are obtained in relation to internal ventilation and expulsion of heat in the temple section 111. A transparent lid may be provided on the emission aperture 114. By providing a lid on the emission aperture 114, infiltration of dust, and the like, is reduced and a beneficial effect in preventing soiling is achieved. When a lid is provided on the emission aperture 114, it is possible to impart a lensing function to a lid which is transparent. The lid of the emission aperture 114 may be formed as a lens which corrects aberration generated by the oblique light incident on the reflecting mirror 104. For example, comatic aberration can be corrected by arranging a wedge prism at the lid of the emission aperture 114, or between the lid and the spatial modulation element 103.

The front section 112 includes a lens section 113, and the reflecting mirror 104 is arranged on the surface of the lens section 113. Furthermore, the front section 112 and the temple section 111 may be bent in order to improve wearability. In this case, the bend position may be an end of the temple section 111 and may be a position on the ear side of the spatial modulation element 103. Similarly to the lens of normal glasses, the lens section 113 may be a lens having a dioptric power for correcting myopia or may be a lens which corrects hyperopia or astigmatism. Furthermore, the lens section 113 may reduce the transmissivity or may have a polarizing function, as in sunglasses. Moreover, the lens section 113 may prevent reflection of unwanted light and may include a film having a function of preventing soiling.

In the first embodiment shown in FIG. 1, a fictive image is displayed to one eye only, but the structure is not limited to this. For example, a spatial modulation element may also be provided in the temple section 115 on the opposite side, so as to form a display device for both eyes. Furthermore, one spatial modulation element may be shared by both eyes. Moreover, it is also possible to use a plurality of spatial modulation elements for one eye.

The distance A (FIG. 6) which is indicated by reference numeral 121 in FIG. 1 shows a distance from an expected eye position of the user (in the present embodiment, the pupil center 191a as described above) to the reflecting mirror 104. The distance B (FIG. 6) which is indicated by reference numeral 122 in FIG. 1 indicates a distance from the reflecting mirror 104 to the spatial modulation element 103. The sum of the distance A and the distance B means the distance from the expected eye position to the spatial modulation element 103 (or the distance of the optical path).

FIG. 6 and FIG. 7 are diagrams which illustrate the positional relationship between the eye 190, the reflecting mirror 104, the spatial modulation element 103 and the fictive image, and the like. FIG. 8A is a diagram showing a fictive image and FIG. 8B is a diagram showing a diffraction pattern which achieves the fictive image shown in FIG. 8A.

The eye 190, the reflecting mirror 104 and the spatial modulation element 103 are arranged as shown in FIG. 6. In a case where the optical magnification of the reflecting mirror 104 is 1, the virtual image 202 of the spatial modulation element 103 is located at the position shown in FIG. 6. The distance 210 from the pupil center of the pupil 191 of the eye 190 to the virtual image 202 is equal to the distance from the pupil center of the pupil 191 of the eye 190 to the spatial modulation element 103, which is the sum of the distance A from the eye 190 to the reflecting mirror 104 and the distance B from the reflecting mirror 104 to the spatial modulation element 103. In the example in FIG. 6, the spatial modulation element 103 is arranged obliquely with respect to the optical axis 220. The distance in this case is a distance with reference to a central point of the spatial modulation element 103. A point other than the central point can be used as a reference.

Furthermore, as shown in FIG. 7, in a case where the optical magnification of the reflecting mirror 104 is greater than 1, the virtual image 302 of the spatial modulation element 103 is situated at the position shown in FIG. 7. In this case, the distance 310 from the pupil center of the pupil 191 of the eye 190 to the virtual image 302 of the spatial modulation element 103 is longer than the distance 210 in the case of FIG. 6, and the virtual image 302 is larger than the virtual image 202.

In the display device 1 according to the present embodiment, the spatial modulation element 103 is arranged inside the temple section 111 as shown in FIG. 1. Therefore, the distance 210 from the pupil center 191a of the pupil 191 of the eye 190 to the spatial modulation element 103 is about 7 cm. The size of this distance 210 varies slightly with the type of the glasses shape, but in a case where the spatial modulation element 103 is arranged on the temple section 111, the distance 210 is generally not more than 10 cm, and as a lower limit, is not less than approximately 2 cm.

On the other hand, the “distance of distinct vision”, which is the shortest distance at which the user's eye 190 can see an object without difficulty, as indicated by reference numeral 211 in FIG. 6 and FIG. 7, varies depending on the user, but is generally taken to be around 25 cm. In the example in FIG. 6, the virtual image 202 of the spatial modulation element 103 is located closer to the eye 190 than the distance of distinct vision 211. Therefore, it is difficult for the user to view the diffraction pattern and image displayed on the spatial modulation element 103.

In the conventional optical magnification method described above, it is necessary for the position of the virtual image of the spatial modulation element to be no closer than the distance of distinct vision, by providing an enlarging optical system between the eye and the spatial modulation element, and accordingly, there is a problem in that the enlarging optical system is large in size.

In the present embodiment, in contrast to a conventional method in which an image displayed to a user is displayed on a spatial modulation element, the diffraction pattern is determined by CGH calculation so that a fictive image that is to be displayed to the user is visible at a distance further than the distance of distinct vision, and the spatial modulation element 103 displays the diffraction pattern thus determined. Consequently, even when the distance to the virtual image of the spatial modulation element 103 is shorter than the distance of distinct vision, it is possible to display a fictive image at a position further than the distance of distinct vision. Therefore, even when the spatial modulation element 103 is arranged in the temple section 111, it is not necessary to increase the optical magnification of the enlarging optical system, leading to increase in the size of the system, and consequently a display device 1 which is a compact glasses type HMD can be achieved.

In the example in FIG. 6, by displaying a diffraction pattern 402 (FIG. 4) on the spatial modulation element 103, the user is able to see the fictive image 401 (FIG. 4), for example, at the position of the fictive image 201, which is further than the distance of distinct vision 211. Here, the distance 212 from the eye 190 to the fictive image can be altered depending on the calculation results of the diffraction pattern and may be set to 200 cm, for example. Therefore, the distance 212 can be made longer than the distance of distinct vision 211. In the example in FIG. 7, similarly, the distance 312 from the pupil 191 of the eye 190 to the fictive image 301 can be made longer than the distance of distinct vision 211.

In the present embodiment, the temple section 111 corresponds to one example of a wearing section, the pupil center 191a of the pupil 191 corresponds to one example of an expected eye position, the emission aperture 114 corresponds to one example of a transmissive aperture, a surface 104a corresponds to one example of a surface on an expected eye position side, a surface 104d corresponds to one example of a surface on an opposite side, and the communication control unit 12 corresponds to one example of a receiving unit.

In this way, in the display device 1 according to the first embodiment, the spatial modulation element 103 is arranged so that the optical axis distance from the pupil center 191a of the pupil 191, which is the expected eye position, to the spatial modulation element 103 is not more than 10 cm, and the spatial modulation element 103 displays a diffraction pattern which causes an image 201 to be displayed virtually at a distance further than the distance from the pupil center 191a to the virtual image 202 of the spatial modulation element 103.

According to this composition, as a result of being able to arrange the spatial modulation element 103 close to the eye 190, a beneficial effect is obtained in that a compact glasses-type display device 1 having excellent wearability on a user's head can be achieved. There is also a beneficial effect in that the illumination optical system 102 which is arranged in the temple section 111 can be made more compact in size. Furthermore, in this case, since a CGH method is employed, the user's eye 190 does not have to focus on the virtual image 202 of the spatial modulation element 103, but rather sees an image by focusing on a fictive image 201 at a further distance, and therefore the display device 1 can be made compact in size by placing the spatial modulation element 103 close to the eye 190, without being restricted by the focusing capability of the eye 190.

Since it is not necessary to view an image on the spatial modulation element 103, as in a conventional optical enlarging system, the requirements for increasing the enlargement magnification are reduced, and hence the occurrence of aberration is also restricted and high quality can be achieved. Furthermore, since the spatial modulation element 103 can be placed close to the eye 190, a large screen size can be achieved with a wide angle of view. Moreover, it is also possible to increase the distance to the fictive image 201 by CGH calculation, and therefore fatigue of the eye 190 caused by focusing can be reduced. Displays suited to the eyes of individuals to account for degrees of myopia, astigmatism, and so on, can be achieved by CGH calculation, and therefore the illumination optical system 102 can be simplified and used commonly, and beneficial effects in terms of achieving compact size, reduced costs and improved reliability are obtained.

Moreover, in the display device 1 according to the first embodiment, the spatial modulation element 103 is arranged so that the distance from the position of the pupil 191 to the virtual image 202 of the spatial modulation element 103 is shorter than a distance of distinct vision of 25 cm, which is the shortest distance at which the user's eye 190 can see an object without difficulty, and the spatial modulation element 103 displays a diffraction pattern which lengthens the distance from the position of the pupil 191 to the fictive image 201 viewed by the user.

According to this composition, the spatial modulation element 103 can be arranged at a close position where the eye 190 cannot focus, and a fictive image 201 can be displayed at a distant position where the eye 190 can focus, while achieving a compact size of the main body and creating the device in the form of glasses. Moreover, even in cases where a lens or mirror for optically enlarging the spatial modulation element 103 is used, beneficial effects are obtained in that the enlargement magnification can be reduced and a display device 1 having high image quality with a more compact size can be achieved.

Furthermore, the display device 1 according to the first embodiment has a reflecting mirror 104 which reflects diffracted light that has been diffracted by the spatial modulation element 103 towards the position of the pupil 191, the display device 1 has the form of glasses, the light source 101, the illumination optical system 102 and the spatial modulation element 103 are arranged inside the temple section 111, and the reflecting mirror 104 is arranged on the surface of the lens section 113 of the front section 112.

According to this composition, a beneficial effect is obtained in that the shape of the display device 1 is made closer to a glasses shape. Furthermore, the freedom of design relating to the glasses shape is increased. In particular, the freedom of design of the shape of the front section 112 of the glasses is increased. Since the reflecting mirror 104 is only required in the lens section 113, it is possible to increase the transmissivity of the lens section 113. The freedom of design of the shape of the lens section 113 can also be increased. Furthermore, a beneficial effect is obtained in that the transmission characteristics and the reflection characteristics of the lens section 113 and the reflecting mirror 104 can be designed independently of the characteristics of the spatial modulation element 103.

In a case where the reflecting mirror 104 is not a diffracting mirror, a beneficial effect is obtained in that the effects of diffraction, such as deviation in diffraction due to stray light or differences in wavelength, can be reduced. Since the light source 101, the illumination optical system 102 and the spatial modulation element 103 are arranged inside the temple section 111, it is possible to make the parts other than the temple section 111 compact in size, and the design freedom can be increased. Moreover, by making the illumination optical system 102 of the temple section 111 compact in size, it is possible to make the temple section 111 compact in size. By designing the illumination optical system 102 with a thin shape, it is possible to design the temple section 111 with a thin shape. For instance, the thickness of the temple section 111 can be smaller and thinner than the height.

Moreover, in the display device 1 according to the first embodiment, the spatial modulation element 103 is a reflective element, and illumination light from the illumination optical system 102 is incident obliquely on the spatial modulation element 103 and is reflected obliquely. The display device 1 does not include a separating optical system which separates the incident light and the reflected light. The spatial modulation element 103 displays a diffraction pattern which causes the display plane of the fictive image 201 displayed to the user to become closer to a plane that is perpendicular with respect to the axis of the diffracted light, compared to the surface of the spatial modulation element 103.

According to this composition, since a reflective element is used for the spatial modulation element 103, a beneficial effect is obtained in that the use efficiency of the light is increased and power savings can be made, compared to a case where a transmissive element is used. Furthermore, since the surface area apart from the pixels of the spatial modulation element 103 is readily reduced, high image quality can be achieved, and a more compact size of the element and narrower dot pitch can be achieved. Since the device does not include a separating optical system, a display device 1 of compact size can be achieved. Furthermore, since the device does not include a separating optical system, the temple section 111 can be made compact in size, and the thickness of the temple section 111 can be made thinner. Even when the spatial modulation element 103 is inclined with respect to the optical axis, the fictive image 201 can be moved closer to a perpendicular position, by CGH calculation. By correcting aberration in the illumination optical system 102 through CGH calculation, the illumination optical system 102 can be made compact in size. Since the spatial modulation element 103 can be arranged obliquely, the freedom of design of the temple section 111 is increased and, for instance, the thickness of the temple section 111 can be reduced. Moreover, by arranging the spatial modulation element 103 obliquely, the dot pitch with respect to the optical axis is narrowed, as a result of which the diffraction angle is broadened, and a wide angle of view and high image quality can be achieved.

Furthermore, in the display device 1 according to the first embodiment, the illumination light emitted onto the spatial modulation element 103 by the illumination optical system 102 is converging light which converges on the pupil center 191a.

According to this composition, the diffraction angle required in the spatial modulation element 103 can be reduced. Consequently, it is possible to achieve a display device 1 having a wider angle of view and a larger screen size. Furthermore, it is possible to achieve a simple illumination optical system 102 and to achieve a compact size thereof, since it is not necessary to split parallel light as in the conventional example. Since converging light converges on the pupil center 191 a of the eye 190, the image quality and the angle of view can be increased focusing at the position of the pupil 191. Since unwanted light outside the position of the eye 190 is reduced and the required amount of light is reduced, beneficial effects are obtained in that the size can be made more compact, higher brightness is achieved, and power savings can be made. Since power savings also lead to a more compact size of the battery 106, it is possible to achieve size and weight reductions.

Furthermore, in the display device 1 according to the first embodiment, the spectral width of the laser light output to the illumination optical system 102 by the light source 101 is not less than 0.1 nm.

According to this composition, the diffraction angle required in the spatial modulation element 103 can be reduced, due to the illumination with converging light by the illumination optical system 102. Consequently, a beneficial effect is obtained in that it is possible to use a light source 101 which outputs laser light having a broader spectral width. Therefore, the light source 101 can be made more compact in size and the cost thereof can be reduced.

Furthermore, in the display device 1 according to the first embodiment, of the diffracted light from the spatial modulation element 103, the amount of transmitted light which is output in a direction opposite to the user's eye 190 by being transmitted through the reflecting mirror 104 is not more than 100 times as large as the amount of reflected light which is reflected in the direction of the user's eye 190 by the reflecting mirror 104.

According to this composition, it is possible to achieve a display device 1 which also provides a display by reflection, as well as increasing the transmissivity of the lens section 113. By making the aforementioned ratio not more than 100 times, the ratio of the amount of transmitted light to the amount of reflected light in the display light is set to less than a hundred percent. Therefore, the amount of unwanted transmitted light in the display light is restricted, without diminishing the brightness of the fictive image 201 displayed by the reflected light. Thus, even in a case where the user's or another user's eye is situated in a position outside the expected eye position, it is possible to reduce the amount of light incident on the eye and hence discomfort to the user can be reduced. Moreover, the output of the light source 101 is reduced and hence a more compact size and power savings can be achieved. There are no particular restrictions on the lower limit of the ratio of the amount of transmitted light to the amount of reflected light, but by making this ratio not less than 10 times, for example, it is possible for the user to see the scene outside appropriately, through the reflecting mirror 104.

Furthermore, in the display device 1 according to the first embodiment, when the incidence angle of the diffracted light incident from the spatial modulation element 103 and the reflection angle of the diffracted light reflected towards the pupil 191 are compared, the region in which the incidence angle is larger than the reflection angle in the reflecting region of the reflecting mirror 104 is broad compared to the region where the incidence angle is smaller than the reflection angle. Moreover, in the reflecting region of the reflecting mirror 104, the region where the incidence angle in the horizontal direction, in a state where the user wearing the temple section 111 on his or her head is standing up, is greater than the incidence angle in the vertical direction is broad compared to the region where the incidence angle in the horizontal direction is smaller than the incidence angle in the vertical direction.

According to this composition, a beneficial effect is obtained in that the inclination of the lens section 113 and the shape of the temple section 111 can be set to a shape which is similar to conventional glasses that have no HMD function. Furthermore, the left and right positions of the fictive image 201 can be brought close to a position in front of the user. The position of the spatial modulation element 103 in the temple section 111 can be close to the front side of the temple section 111, which makes it possible to achieve a temple shape in which the front end of the temple section 111 close to the lens section 113 has a greater height than the portion of the temple section 111 close to ear. Furthermore, it is possible to achieve a display device 1 in which the display light directed towards the reflecting mirror 104 from the spatial modulation element 103 is not shielded by a portion of the user's face at the periphery of the corner of the user's eye which is positioned between the spatial modulation element 103 and the reflecting mirror 104.

The optical magnification of the reflecting mirror 104 may vary between the horizontal direction and the vertical direction. By making the magnification of the reflecting mirror 104 in the horizontal direction larger than the magnification in the vertical direction, it is possible to achieve a fictive image 201 having a broad lateral width and it is possible to preferentially enlarge the lateral width which is narrowed by arranging the spatial modulation element 103 obliquely with respect to the optical axis of the illumination light.

Furthermore, in the display device 1 according to the first embodiment, the reflecting mirror 104 includes a Fresnel lens 742. The Fresnel lens 742 and the lens section 113 which are bonded by the adhesive 741 have the following interfaces, in order from the face side to the outer side: a face side surface 104a, a Fresnel lens surface 104b, a bonding surface 104c and an outer side surface 104d. The refractive index of the medium between the face side surface 104a and the Fresnel lens surface 104b (in other words, the Fresnel lens 742) and the refractive index of the medium between the Fresnel lens surface 104b and the bonding surface 104c (in other words, the adhesive 741) are equal.

According to this composition, a beneficial effect is obtained in that the shape and inclination of the lens section 113 are close to those of conventional glasses which do not have an HMD function. The shape of the reflecting mirror 104 can be made thin and the incidence angle and the reflection angle can be designed freely. It is possible to achieve a display device 1 in which the diffracted light from the spatial modulation element 103 which is arranged in the temple section 111 is reflected just as if arriving at the user from the front, while suppressing distortion of the scene outside by causing the transmitted light of the outside world to be transmitted straight. Furthermore, since a Fresnel lens 742 is used rather than a diffracting element in the reflecting mirror 104, it is possible to avoid the effects of unwanted diffracted light or the effects of variation in the diffraction angle.

Furthermore, the display device 1 according to the first embodiment may use an element having one or more defective pixels as the spatial modulation element 103.

According to this composition, a beneficial effect is obtained in that a low-cost display device 1 can be achieved by using a spatial modulation element 103 of lower cost. Even if one pixel of the diffraction pattern is defective, the overall noise of the fictive image 401 is simply increased and a pixel is not omitted in the fictive image 401. Therefore, a beneficial effect is obtained in that it is possible to achieve a display device 1 in which the effects of defective pixels are not localized.

Moreover, the display device 1 according to the first embodiment includes a communication control unit 12, and the communication control unit 12 receives the diffraction pattern from an external source by radio communication, and causes the spatial modulation element 103 to display the received diffraction pattern.

According to this composition, the calculation of the diffraction pattern is not carried out in the main body of the display device 1. As a result of this, a beneficial effect is obtained in that it is possible to achieve a compact size and reduced weight of the display device 1. Furthermore, a beneficial effect is also obtained in that it is possible to reduce the generation of heat by the circuitry which carries out the calculation of the circuit pattern. Moreover, since a battery 106 is provided, a beneficial effect is obtained in that it is possible to achieve a wireless display device 1 which does not require a control line or power supply line. Moreover, since power savings can be made in the wireless display device 1, a beneficial effect is obtained in that the continuous use time until recharging of the battery 106 can be lengthened.

In the first embodiment described above, moreover, an external device may send information that can relate to the wavelength variation of the illumination light by radio communication. The communication control unit 12 may change the acquired diffraction pattern to reduce the effects of wavelength variation on the basis of the received information. Consequently, a beneficial effect is obtained in that it is possible to reduce deterioration in image quality caused by environmental changes, and the like. The transmitted information may include information about the temperature of the optical system, such as the light source 101, the air temperature, the state of the returning laser light, the laser intensity, the diffraction angle, and the like, and changes in these values. Information may be transmitted from the external device within a prescribed time period after the power to the display device 1 has been switched on.

Moreover, in the first embodiment described above, as shown in FIG. 3, the illumination optical system 102 causes the illumination light to converge on the pupil center 191a of the pupil 191 of the eye 190, but the present invention is not limited to this. For instance, the illumination light may also be caused to converge on the center of the eyeball of the eye 190.

FIG. 9 is a diagram showing an illumination optical system different from the illumination optical system shown in FIG. 3. The illumination light is light that converges on the eye 190, similarly to FIG. 3, but the center of convergence of the illumination light is the eyeball center 192 of the eye 190, rather than the center of the pupil. The larger the virtual image of the spatial modulation element 103 and the wider the angle of view of the fictive image, the further the eye 190 rotates and the pupil moves when viewing the ends of the fictive image in a central visual field. For example, when the diffracted light from the center of the spatial modulation element 103 in FIG. 9 is viewed in a central visual field, the pupil is located at a position 621, but the pupil moves to a position 622 when viewing the diffracted light from the upper end of the spatial modulation element 103 in the central visual field.

Therefore, desirably, the width 612 at the pupil position of the converging light is broader than the pupil size, so as to include the pupil at the positions 621 and 622. Here, as shown in FIG. 9, a beneficial effect is obtained in that the diffraction angle required in the spatial modulation element 103 can be reduced, by converting the illumination light into converging light which converges on the eyeball center 192, and making the width 613 of the diffraction range at the pupil position, which corresponds to the diffraction angle 601, smaller than the width 612. When the required diffraction angle can be reduced, as described above, it is possible to allow a broader dot pitch in the spatial modulation element 103 and further increase in the size of the screen can be achieved. Furthermore, as shown in FIG. 9, the width 612 of the converging light at the pupil position is smaller than the width 611 of the spatial modulation element 103. In the embodiment shown in FIG. 9, the eyeball center 192 corresponds to one example of an expected eye position, the width 611 of the spatial modulation element 103 corresponds to one example of W1, the width 612 of the converging light at the pupil position corresponds to one example of W2, and the width 613 of the diffraction range at the pupil position corresponds to one example of W3.

In this way, in the display device according to the embodiment shown in FIG. 9, of the width 611 of the spatial modulation element 103, the width 612 of the converging light at the user's pupil position, and the width 613 of the diffraction range at the pupil position, which is dependent on the upper limit of the diffraction angle which is determined in accordance with the fineness of the stripes in the diffraction pattern, the width 612 is not more than the width 611 and is not less than the width 613.

According to this composition, a beneficial effect is obtained in that a display device having a wider angle of view can be achieved, that a larger spatial modulation element 103 can be used, that a fictive image can be continuously displayed even when the eye 190 is rotated, and that it is also possible to improve the image quality at the point of regard (central visual field) than that at the peripheral visual field.

Furthermore, in the first embodiment described above, as shown in FIG. 3, the illumination optical system 102 causes the illumination light to converge at the pupil center 191a of the eye 190, and in the embodiment shown in FIG. 9, causes the illumination light to converge at the eyeball center 192 of the eye 190, but the present invention is not limited to this. For example, the illumination optical system 102 may set the center of convergence of the illumination light to a position on a line segment from the pupil center 191a to the eyeball center 192.

According to this composition, in a case where the center of convergence of the illumination light is situated at the pupil center 191a, a beneficial effect is obtained in that it is possible to achieve a display device 1 which gives preference to the display characteristics when the pupil 191 is situated to the front with respect to the user's head. In a case where the center of convergence of the illumination light is situated at the eyeball center 192, a beneficial effect is obtained in that it is possible to achieve a display device 1 which gives preference to the display characteristics when a fictive image is viewed by rotating the eye 190. By setting the center of convergence of the illumination light to a position on a line segment from the pupil center 191a to the eyeball center 192, a beneficial effect is obtained in that the balance between these display characteristics can be specified freely.

Furthermore, in the first embodiment, the illumination optical system 102 may converge the illumination light so that the center of convergence of the illumination light differs in the horizontal direction and the vertical direction, and so that the center of convergence in the horizontal direction is closer to the eyeball center 192 than the center of convergence in the vertical direction. In other words, the illumination optical system 102 may produce a different degree of convergence of the illumination light in the horizontal direction and the vertical direction.

According to this composition, a beneficial effect is obtained in that it is possible to achieve a display device 1 which is suited to a fictive image of horizontally long.

### Second Embodiment

FIG. 10 is a block diagram showing an electrical composition of a display device according to a second embodiment of the present invention. In the second embodiment, elements which are similar to the first embodiment are labeled with the same reference numerals. Below, the second embodiment is described with particular reference to the points of difference with respect to the first embodiment.

In the display device 1a according to the second embodiment shown in FIG. 10, the control unit 105 includes an element control unit 13 instead of the communication control unit 12, in comparison with the display device 1 according to the first embodiment shown in FIG. 2. The composition of the second embodiment other than this is the same as the first embodiment.

The element control unit 13 calculates a diffraction pattern (a diffraction pattern 402 which is shown in FIG. 8B, for instance), from a desired fictive image (the fictive image 401 shown in FIG. 8A, for instance). The element control unit 13 controls the spatial modulation element 103 to cause the spatial modulation element 103 to display the calculated diffraction pattern.

The method by which the element control unit 13 determines the diffraction pattern 402 from the fictive image 401 may be a common method used in CGH. For example, in a point filling method, it is possible to generate a diffraction pattern which is displayed on the spatial modulation element 103 of a phase modulation type, by determining the intensity and the phase of the wave front at the pixel positions of the spatial modulation element 103 from the intensity and phase of the wave front of the light emitted from the respective pixels of the fictive image, and converting, for each pixel of the spatial modulation element 103, the two-dimensional vector values of the determined intensity and phase into one-dimensional phase values (see Patent Document 2). In a point filling method, calculations can be made by freely setting the distance from the fictive image to the spatial modulation element 103, and the degree of divergence and convergence of the laser light which illuminates the spatial modulation element 103, and the like. Furthermore, in order to accelerate the point filling method, it is possible to adopt a diffraction pattern calculation method which partly uses a fast Fourier transform (FFT). In the present embodiment, the element control unit 13 corresponds to one example of a calculation unit.

In this second embodiment also, similar beneficial effects to those of the first embodiment can be obtained. In a case where the width 613 is smaller than the width 612 as shown in FIG. 9, the method for calculating the diffraction pattern by the element control unit 13 may be simplified. For example, the calculation method may use the pixel values of the upper end of the fictive image which is displayed to the user in only a portion of the upper part of the diffraction pattern and not use these pixel values in the calculation of the lower part of the diffraction pattern, rather than in the whole surface of the diffraction pattern which is displayed on the spatial modulation element 103. Consequently, it is possible to reduce the amount of calculation for calculating the diffraction pattern.

### Third Embodiment

FIG. 11 is a block diagram showing an electrical composition of a display device according to a third embodiment of the present invention. In the third embodiment, elements which are similar to the first and second embodiments are labeled with the same reference numerals. Below, the third embodiment is described with particular reference to the points of difference with respect to the first and second embodiments.

The display device 1b according to the third embodiment shown in FIG. 11 includes an element control unit 13a instead of the communication control unit 12, and also includes a diffraction angle information acquisition unit 107, in comparison with the display device 1 according to the first embodiment shown in FIG. 2. The composition of the third embodiment other than this is the same as the first embodiment.

The diffraction angle information acquisition unit 107 acquires information relating to variation in the diffraction angle in the spatial modulation element 103. In this embodiment, the diffraction angle information acquisition unit 107 includes, for example, a temperature sensor 21, a timer 22, and optical sensors 23, 24. The temperature sensor 21 detects the temperature of the light source 101. The timer 22 counts the lighting time of the light source 101. The optical sensor 23 detects an intensity of the laser light which is output from the light source 101. The optical sensor 24 detects a diffraction angle of diffracted light which is diffracted by the spatial modulation element 103.

The element control unit 13a calculates a diffraction pattern (a diffraction pattern 402 which is shown in FIG. 8B, for instance), from a desired fictive image (the fictive image 401 shown in FIG. 8A, for instance). The element control unit 13a changes the diffraction pattern using values detected by the diffraction angle information acquisition unit 107. The element control unit 13a controls the spatial modulation element 103 to cause the spatial modulation element 103 to display the changed diffraction pattern.

When the temperature of the light source 101 rises and the wavelength of the laser light output from the light source 101 changes, the diffraction angle of the diffracted light which is diffracted by the spatial modulation element 103 changes. Furthermore, when the lighting time of the light source 101 becomes longer, the temperature of the light source 101 rises, and when the intensity of the laser light output from the light source 101 increases, the temperature of the light source 101 rises, and in a similar fashion, the diffraction angle of the diffracted light which is diffracted by the spatial modulation element 103 changes. Consequently, in a case where the same diffraction pattern is displayed on the spatial modulation element 103 even when the diffraction angle changes, a desired fictive image cannot be obtained. Therefore, in this third embodiment, information relating to change in the diffraction angle at the spatial modulation element 103 is acquired by the diffraction angle information acquisition unit 107, and the element control unit 13a changes the diffraction pattern to be calculated on the basis of this information. In the present embodiment, the element control unit 13a corresponds to one example of a calculation unit and the diffraction angle information acquisition unit 107 corresponds to one example of the acquisition unit.

Therefore, according to this third embodiment, a beneficial effect is obtained in that it is possible to reduce deterioration of image quality due to change in the diffraction angle resulting from variation in the wavelength of the light source 101, and the like. Furthermore, in the third embodiment, change in the diffraction angle is handled by CGH calculation by the element control unit 13a, rather than by controlling the movement of the illumination optical system 102 or the reflecting mirror 104. Therefore, a beneficial effect is obtained in that the illumination optical system 102 and the reflecting mirror 104 can be made compact in size and simplified, the costs thereof can be reduced and long life-span thereof can be achieved. Moreover, a beneficial effect is also obtained in that it is possible to enhance the environmental adaptability of the display device 1b, such as the usable temperature range thereof.

The diffraction angle information acquisition unit 107 may include any one of the temperature sensor 21, the timer 22, and the optical sensors 23, 24, and not include the others thereof. In this embodiment also, the diffraction angle information acquisition unit 107 can acquire information relating to change in the diffraction angle. In other words, the diffraction angle information acquisition unit 107 need only include at least one of the temperature sensor 21, the timer 22 and the optical sensors 23, 24.

### Fourth Embodiment

FIG. 12 is a block diagram showing an electrical composition of a display device according to a fourth embodiment of the present invention. In the fourth embodiment, elements which are similar to the first embodiment are labeled with the same reference numerals. Below, the fourth embodiment is described with particular reference to the points of difference with respect to the first embodiment.

The display device 1c according to the fourth embodiment shown in FIG. 12 includes a light source control unit 11a instead of the light source control unit 11, and also includes a communication control unit 12a instead of the communication control unit 12, in comparison with the display device 1 according to the first embodiment shown in FIG. 2. Furthermore, the light source 101 includes a red light source 31, a green light source 32 and a blue light source 33. The composition of the fourth embodiment other than this is the same as the first embodiment.

The red light source 31 includes a semiconductor laser which outputs laser light of a red wavelength. The green light source 32 includes a semiconductor laser which outputs laser light of a green wavelength. The blue light source 33 includes a semiconductor laser which outputs laser light of a blue wavelength. The green light source 32 may include a semiconductor laser which outputs infrared laser light and a second harmonic generating (SHG) element which converts the infrared light into green light.

The light source control unit 11a drives the red light source 31, the green light source 32 and the blue light source 33, by time division. The communication control unit 12a has a radio communication function and acquires diffraction patterns corresponding respectively to the three colors which are transmitted from an external device. The communication control unit 12a controls the spatial modulation element 103 to cause the spatial modulation element 103 to display the acquired diffraction patterns in synchronization with the red light source 31, the green light source 32 and the blue light source 33, which are driven by time division. Consequently, it is possible to display a color fictive image.

In this embodiment, the red light source 31, the green light source 32 and the blue light source 33 each have characteristics whereby the spectral width of the laser light output to the illumination optical system 102 is broader in the case of pulse lighting than in the case of constant lighting.

In this way, in the fourth embodiment, similarly to the first embodiment, it is possible to reduce the required diffraction angle in the spatial modulation element 103, by illumination of converging light by the illumination optical system 102. Therefore, the spatial modulation element 103 can tolerate a broader spectral width as the spectral width of the laser light output from the light source 101. As a result of this, a beneficial effect is also obtained in that it is possible to achieve a color display appropriately, by time division driving of the three color light sources, the red light source 31, the green light source 32 and the blue light source 33. Furthermore, a beneficial effect is also obtained in that it is possible to achieve a compact size of and to reduce the cost of the red light source 31, the green light source 32 and the blue light source 33, which are used in the light source 101.

In the fourth embodiment described above, the light sources 31, 32, 33 of three colors are applied to the first embodiment, but this is not limited to the present embodiment and may also be applied to the second embodiment. More specifically, in the second embodiment, the light source 101 may include a red light source 31, a green light source 32 and a blue light source 33. The element control unit 13 may calculate a diffraction pattern corresponding to each of the three colors and cause the spatial modulation element 103 to display each diffraction pattern in synchronization with the light sources 31, 32, 33 which are driven by time division.

### Fifth Embodiment

FIG. 13 is a block diagram showing an electrical composition of a display device according to a fifth embodiment of the present invention. In the fifth embodiment, elements which are similar to the first embodiment are labeled with the same reference numerals. Below, the fifth embodiment is described with particular reference to the points of difference with respect to the first embodiment.

The display device 1d according to the fifth embodiment shown in FIG. 13 includes a communication control unit 12b instead of the communication control unit 12, and additionally includes a storage unit 108, in comparison with the display device 1 according to the first embodiment shown in FIG. 2. The composition of the fifth embodiment other than this is the same as the first embodiment.

The storage unit 108 stores the degree of myopia of a user. The communication control unit 12b has a radio communication function and acquires a diffraction pattern which is transmitted from an external device. The communication control unit 12b changes the distance from the expected eye position to the fictive image, in accordance with the degree of myopia stored in the storage unit 108, in respect of the acquired diffraction pattern. The communication control unit 12b controls the spatial modulation element 103 to cause the spatial modulation element 103 to display the changed diffraction pattern.

According to the fifth embodiment, a beneficial effect is obtained in that it is possible to respond to different degrees of myopia of different users, by means of a simple optical system.

Furthermore, according to the fifth embodiment, a response to the degree of myopia is provided by the diffraction pattern displayed on the spatial modulation element 103, rather than the illumination optical system 102. Accordingly, a beneficial effect is obtained in that it is possible to reduce the portion of the illumination optical system 102 which is driven physically, and a more compact size, simpler structure and lower costs can be achieved, in addition to which the breakdown rate can be reduced. Furthermore, since the degree of myopia of the user is stored in the storage unit 108, a beneficial effect is obtained in that it is possible to reduce the work involved in setting up the illumination optical system 102 and the spatial modulation element 103, each time the device is used.

In the fifth embodiment described above, the storage unit 108 is applied to the first embodiment, but the embodiment is not limited to this and the storage unit 108 may also be applied to the second embodiment. In other words, the second embodiment may include a storage unit 108. The element control unit 13 may calculate a diffraction pattern having a distance corresponding to the degree of myopia stored in the storage unit 108 as the distance from the expected eye position to the fictive image, and cause the spatial modulation element 103 to display the calculated diffraction pattern.

### Sixth Embodiment

FIG. 14 is a block diagram showing an electrical composition of a display device according to a sixth embodiment of the present invention. In the sixth embodiment, elements which are similar to the first embodiment are labeled with the same reference numerals. Below, the sixth embodiment is described with particular reference to the points of difference with respect to the first embodiment.

The display device 1e according to the sixth embodiment shown in FIG. 14 includes a communication control unit 12c instead of the communication control unit 12, and additionally includes a wearing sensor 109, in comparison with the display device 1 according to the first embodiment shown in FIG. 2. The composition of the sixth embodiment other than this is the same as the first embodiment.

The wearing sensor 109 detects whether or not the user is wearing the display device 1e. The wearing sensor 109 may use a pressure sensor or reflective optical sensor which is provided in the temple section 111, for example. For instance, with a pressure sensor, it is possible to detect the pressure created by wearing the device on the user's head. Furthermore, with a reflective optical sensor, for instance, it is possible to detect the reflection of light from the head. Moreover, the wearing sensor 109 may detect the opened or closed state of the temple section 111 and the front section 112, and judge that the user is wearing the display device le when this state is opened.

The communication control unit 12c changes the state of the display on the spatial modulation element 103 by recognizing the wearing state of the display device 1e on the user, on the basis of the detection results by the wearing sensor 109. When the wearing sensor 109 detects that the display device 1e is being worn on the user's head, for instance, the communication control unit 12c automatically starts the display of a diffraction pattern on the spatial modulation element 103. When the wearing sensor 109 detects that the display device 1e is not being worn on the user's head, for instance, the communication control unit 12c automatically terminates the display of a diffraction pattern on the spatial modulation element 103 after a prescribed period of time.

Moreover, the communication control unit 12c may also display a normal image, instead of displaying a diffraction pattern on the spatial modulation element 103, when the display device 1e is not being worn. Consequently, a beneficial effect is obtained in that it is possible to notify the user of information even before the user is wearing glasses (in other words, before wearing the display device le on the head), by displaying information such as incoming mail, or the like, on the spatial modulation element 103, by the communication control unit 12c. Alternatively, the communication control unit 12c may perform the display of a diffraction pattern and the display of an image on the spatial modulation element 103, simultaneously.

In the sixth embodiment described above, the wearing sensor 109 is applied to the first embodiment, but the embodiment is not limited to this and may also be applied to the second embodiment. In other words, the second embodiment may include a wearing sensor 109. The element control unit 13 may control the display on the spatial modulation element 103 in accordance with the wearing state of the display device 1a on the head.

### Seventh Embodiment

FIG. 15 is a block diagram showing an electrical composition of a display device according to a seventh embodiment of the present invention. FIG. 16 is a diagram showing a composition of the principal part of a display device according to the seventh embodiment of the present invention. In the seventh embodiment, elements which are similar to the first embodiment are labeled with the same reference numerals. Below, the seventh embodiment is described with particular reference to the points of difference with respect to the first embodiment.

The display device 1f according to the seventh embodiment shown in FIG. 15 includes a communication control unit 12d instead of the communication control unit 12, and additionally includes a spatial modulation element 803, separately from the spatial modulation element 103, in comparison with the display device 1 according to the first embodiment which is shown in FIG. 2.

The display device 1f in FIG. 16 has the form of glasses similarly to the first embodiment, but in contrast to the first embodiment, has characteristics whereby the spatial modulation element 103 is arranged on the lens section 113 rather than the temple section 111 (FIG. 1). The display device 1f according to the present embodiment has a further spatial modulation element 803 in addition to the spatial modulation element 103. The spatial modulation element 103 and the spatial modulation element 803 are arranged in overlapping fashion in the optical axis direction of the diffracted light, on the lens section 113 of the front section 112 (FIG. 1).

The communication control unit 12d causes the spatial modulation element 803 to display a diffraction pattern (for example, an inverse pattern to the diffraction pattern displayed by the spatial modulation element 103) which cancels out phase modulation, in the spatial modulation element 103, to transmitted light from scene outside. An illumination optical system 102 is arranged between the spatial modulation element 103 and the spatial modulation element 803, and illuminates the spatial modulation element 103 with the laser light from the light source 101. In this embodiment, the spatial modulation element 103 and the spatial modulation element 803 are both transmissive elements.

According to the seventh embodiment, since the lens section 113 has a display function, a reflecting mirror is not necessary, and a beneficial effect is obtained in that the display device 1f can be made more compact in size and simpler. Moreover, according to the seventh embodiment, a beneficial effect is obtained in that it is possible to make the temple section 111 compact in size, since there is no need to arrange a spatial modulation element in the temple section 111 (FIG. 1). Furthermore, in the seventh embodiment, it is possible to reduce the distance from the pupil 191 of the eye 190 to the spatial modulation element 103. Consequently, according to the seventh embodiment, a beneficial effect is obtained in that it is possible to achieve a wider angle of view and larger screen size of the display device 1f. Furthermore, in the seventh embodiment, the spatial modulation element 803 displays a diffraction pattern which cancels out phase modulation, in the spatial modulation element 103, to transmitted light from scene outside, and therefore a beneficial effect is obtained in that it is possible to reduce distortion of the scene outside caused by the spatial modulation element 103.

In the seventh embodiment described above, the spatial modulation element 803 is applied to the first embodiment, but the embodiment is not limited to this and the spatial modulation element 803 may also be applied to the second embodiment. In other words, the second embodiment may include a spatial modulation element 803. The element control unit 13 may calculate a diffraction pattern which cancels out phase modulation, in the spatial modulation element 103, to transmitted light from scene outside, and cause the spatial modulation element 803 to display the diffraction pattern thus calculated.

### Others

In the respective embodiments described above, the display device has the form of glasses, as shown in FIG. 1, but the present invention is not limited to this, provided that the display device is worn on the head of a user.

FIG. 17 is a diagram showing a schematic view of one example of a display device having a form different to glasses. The display device 1g shown in FIG. 17 includes a frame section 200 which is belt-shaped, for instance, for wearing on a user's head, a temple section 111a which is connected to this frame section 200, a front section 112a which is connected to the temple section 111a, and a lens section 113a which is formed on the front section 112a. In the display device 1g, the respective members of the spatial modulation element 103 (FIG. 1), and the like, are arranged similarly to FIG. 1. In the display device 1g shown in FIG. 17, it is possible to obtain similar beneficial effects to the respective embodiments described above. In the embodiment shown in FIG. 17, the frame section 200 and the temple section 111a correspond to one example of the wearing section.

Furthermore, a portion of the functions of each part of the display device 1 and the like, described in the respective embodiments given above may be achieved by means of a device which is separate from the main body of the display device 1 and the like. Moreover, functions which are not described in the respective embodiments given above may be installed in the display device 1 and the like. The functions may also be shared between the main body of the display device 1 and the like, and a portable terminal, for instance, which is separate from the display device 1 and the like. Furthermore, the functions may be shared between the display device 1 and the like, and a network server.

Moreover, in the second embodiment described above, calculation of the diffraction pattern is carried out by the element control unit 13 of the display device 1a, and in the first embodiment described above, a diffraction pattern determined by an external device is acquired by the communication control unit 12 of the display device 1. However, the embodiment is not limited to this, and a portion of the calculation of the diffraction pattern may be carried out externally, the results of this may be acquired by the communication control unit 12, and the remainder of the calculation of the diffraction pattern may be carried out by the communication control unit 12.

Furthermore, in the respective embodiments given above, the light source 101 may be provided in an external device, and light output from the light source 101 may be transmitted by an optical fiber. Moreover, the battery 106 may be provided in an external device and a power cord may be connected to the display device 1 and the like. Furthermore, the display device 1 and the like, may include other functions, such as a camera, a variety of sensors including an angular velocity sensor, a temperature sensor and a GPS, an input device such as a switch, an output device such as a speaker, and so on.

According to the respective embodiments described above, the display device 1 and the like, includes an illumination optical system 102 which emits illumination light which is laser light, a spatial modulation element 103 which diffracts the illumination light by displaying a diffraction pattern, and a temple section 111 for wearing on a user's head. Moreover, in the display device 1 and the like, the positional relationship between the spatial modulation element 103 and the user's expected eye position is fixed when the temple section 111 is being worn on the user's head. Furthermore, in the display device 1 and the like, the distance from the eye 190 to the virtual image 202 of the spatial modulation element 103, is shorter than the distance of distinct vision, and the distance from the eye 190 to the fictive image 201 is longer than the distance of distinct vision. Therefore, it is possible to achieve a display device 1 and the like, in which a large screen size is achieved, by distant display of the fictive image 201, while making the device compact in size. Furthermore, it is also possible to display a three-dimensional image to the user by causing the spatial modulation element 103 to display a diffraction pattern corresponding to the three-dimensional image.

The concrete embodiments described above principally include an invention having the following composition.

The display device according to one aspect of the present invention includes: a light source which outputs laser light; an illumination optical system which emits the laser light as illumination light; a spatial modulation element which diffracts the illumination light by displaying a diffraction pattern; and a wearing section for wearing on a user's head, wherein a positional relationship between the spatial modulation element and an expected eye position, which is expected to be a position of an eye of the user, is fixed in a state where the wearing section is worn on the user's head, and the spatial modulation element displays, as the diffraction pattern, a diffraction pattern by which a fictive image is displayed to the user due to diffracted light, which has been diffracted by the diffraction pattern, reaching the expected eye position.

According to this composition, the light source outputs laser light. The illumination optical system emits the laser light as illumination light. The spatial modulation element diffracts the illumination light by displaying a diffraction pattern. The wearing section is for wearing on the user's head. The positional relationship between the spatial modulation element and the expected eye position, which is expected to be the position of the user's eye, is fixed in a state where the wearing section is worn on the user's head. The spatial modulation element displays as the diffraction pattern, a diffraction pattern by which a fictive image is displayed to the user due to diffracted light, which has been diffracted by the diffraction pattern, reaching the expected eye position. Consequently, in contrast to a conventional optical enlarging system, it is possible to determine by the diffraction pattern the distance from the user's eye to the fictive image displayed to the user, separately from the distance from the user's eye to the spatial modulation element. As a result of this, it is possible to provide a display device which is capable of achieving both a compact size of the device, and a large screen size (a wide angle of view) by distant display of the fictive image which is displayed to the user.

Furthermore, in the display device described above, desirably, the spatial modulation element is arranged at a position in which an optical axis distance from the expected eye position to the spatial modulation element is not more than 10 cm in a state where the wearing section is worn on the user's head, and the spatial modulation element displays the diffraction pattern which causes the fictive image to be displayed at a further distance than a distance from the expected eye position to a virtual image of the spatial modulation element.

According to this composition, the spatial modulation element is arranged at a position in which an optical axis distance from the expected eye position to the spatial modulation element is not more than 10 cm in a state where the wearing section is being worn on the user's head. The spatial modulation element displays the diffraction pattern which causes the fictive image to be displayed at a further distance than the distance from the expected eye position to the virtual image of the spatial modulation element. Consequently, it is possible to arrange the spatial modulation element close to the eye. As a result of this, a beneficial effect is obtained in that it is possible to achieve a display device which is compact and has excellent wearability on a user's head. Furthermore, since the fictive image is displayed to the user by displaying a diffraction pattern on the spatial modulation element, the user's eye is not required to focus on the virtual image of the spatial modulation element, and the user can see an image by focusing on a more distant fictive image. Consequently, a beneficial effect is obtained in that it is possible to make the device more compact, by placing the spatial modulation element close to the user's eye, without being restricted to the focusing capability of the eye.

Furthermore, since there is no need to view the image on the spatial modulation element, as in a conventional optical enlarging system, the need to increase the enlarging magnification is also reduced. As a result of this, a beneficial effect is also obtained in that the occurrence of aberration is suppressed and high image quality can be achieved. Furthermore, since the spatial modulation element is placed close to the eye, a beneficial effect is also obtained in that a large screen size can be achieved with a wide angle of view. Moreover, since the distance to the fictive image can be increased by the diffraction pattern which is displayed on the spatial modulation element, a beneficial effect is also obtained in that fatigue of the eye caused by focusing can be reduced.

Furthermore, in the display device described above, desirably, the spatial modulation element is arranged at a position in which a distance from the expected eye position to a virtual image of the spatial modulation element is shorter than a distance of distinct vision of 25 cm, and the spatial modulation element displays the diffraction pattern by which a distance from the expected eye position to the fictive image is longer than the distance of distinct vision.

According to this composition, the spatial modulation element is arranged at a position in which a distance from the expected eye position to the virtual image of the spatial modulation element is shorter than a distance of distinct vision of 25 cm. The spatial modulation element displays the diffraction pattern by which a distance from the expected eye position to the fictive image viewed by the user is longer than the distance of distinct vision. Consequently, it is possible to arrange the spatial modulation element at a position close to the eye where the eye cannot focus. As a result of this, a beneficial effect is obtained in that it is possible to display a fictive picture plane at a distant position where the eye can focus, while making the main body of the device more compact in size.

Furthermore, desirably, the display device described above further includes a reflecting mirror which reflects the diffracted light, which has been diffracted by the spatial modulation element, towards the expected eye position, wherein the light source, the illumination optical system and the spatial modulation element are arranged in a void formed inside the wearing section, and the reflecting mirror is arranged in front of the expected eye position in a state where the wearing section is worn on the user's head.

According to this composition, the reflecting mirror reflects the diffracted light, which has been diffracted by the spatial modulation element, towards the expected eye position. The light source, the illumination optical system and the spatial modulation element are arranged in a void formed inside the wearing section. The reflecting mirror is arranged in front of the expected eye position in a state where the wearing section is worn on the user's head. Consequently, a beneficial effect is obtained in that it is possible to design the transmissive characteristics and the reflection characteristics of the reflecting mirror independently of the characteristics of the spatial modulation element. Moreover, since the light source, the illumination optical system and the spatial modulation element are arranged inside the wearing section, a beneficial effect is obtained in that it is possible to make the parts other than the wearing section compact in size, and the freedom of design can be increased.

Furthermore, in the display device described above, desirably, the spatial modulation element is a reflective element, the spatial modulation element is arranged with respect to the illumination optical system so that the illumination light emitted from the illumination optical system is incident obliquely on a surface of the spatial modulation element, and the spatial modulation element displays the diffraction pattern by which a display plane of the fictive image displayed to the user is closer to perpendicular with respect to the optical axis of the diffracted light than a surface of the spatial modulation element.

According to this composition, the spatial modulation element is a reflective element. The spatial modulation element is arranged with respect to the illumination optical system so that the illumination light emitted from the illumination optical system is incident obliquely on a surface of the spatial modulation element. The spatial modulation element displays the diffraction pattern by which a display plane of the fictive image displayed to the user is closer to a plane that is perpendicular with respect to the optical axis of the diffracted light, compared to the surface of the spatial modulation element. Therefore, since the spatial modulation element is a reflective element, a beneficial effect is obtained in that the light use efficiency is increased and power savings can be made in comparison with a transmissive element. Furthermore, since the area apart from the pixels of the spatial modulation element is readily reduced, a beneficial effect is also obtained in that high image quality can be achieved, and in that a more compact size of the element and narrower dot pitch can be achieved.

Furthermore, since the illumination light is incident obliquely on the surface of the spatial modulation element, an optical system for separating the incident light and the reflected light is not necessary. Consequently, a beneficial effect is obtained in that it is possible to make the wearing section compact in size, and to reduce the thickness of the wearing section. As a result of this, a beneficial effect is obtained in that it is possible to achieve a display device of compact size. Furthermore, the spatial modulation element displays a diffraction pattern which causes the display plane of the fictive image displayed to the user to become closer to perpendicular with respect to the optical axis of the diffracted light, compared to the surface of the spatial modulation element. Therefore, a beneficial effect is obtained in that even when the spatial modulation element is inclined with respect to the optical axis, the fictive image can be brought close to perpendicular with respect to the optical axis. Since the spatial modulation element can be arranged obliquely with respect to the illumination optical system, a beneficial effect is obtained in that the freedom of design of the wearing section can be increased and the thickness of the wearing section, for instance, can be reduced. Moreover, by arranging the spatial modulation element obliquely, the dot pitch with respect to the optical axis is narrowed, as a result of which a beneficial effect is also obtained in that the diffraction angle can be broadened, and a wide angle of view and high image quality can be achieved.

Furthermore, in the display device described above, desirably, a transmissive aperture is formed in the wearing section so that the diffracted light diffracted by the spatial modulation element reaches the expected eye position, and the periphery of the transmissive aperture in the wearing section shields light so that unwanted diffracted light, which is generated by incidence of external light other than the illumination light on the spatial modulation element, does not reach the expected eye position.

According to this composition, a transmissive aperture is formed in the wearing section so that the diffracted light diffracted by the spatial modulation element reaches the expected eye position. The periphery of the transmissive aperture in the wearing section shields light so that unwanted diffracted light, which is generated by incidence of external light other than the illumination light on the spatial modulation element, does not reach the expected eye position. Consequently, a beneficial effect is obtained in that it is possible to reduce unwanted light caused by diffraction. Since the diffraction by the spatial modulation element is performed in the wearing section, rather than the reflecting mirror, a beneficial effect is obtained in that countermeasures against unwanted diffracted light are not required in the reflecting mirror. Since countermeasures against unwanted diffracted light are simplified, a beneficial effect is obtained in that a display device which has little unwanted diffracted light can be achieved, even in circumstances where unwanted diffracted light is generally liable to occur, such as outdoors or at night time.

Furthermore, in the display device described above, desirably, an amount of transmitted light of the diffracted light which is transmitted by the reflecting mirror and output in an opposite direction to the expected eye position is not more than 100 times larger than an amount of reflected light of the diffracted light which is reflected by the reflecting mirror towards the expected eye position.

According to this composition, an amount of transmitted light of the diffracted light which is transmitted by the reflecting mirror and output in an opposite direction to the expected eye position is not more than 100 times larger than an amount of reflected light of the diffracted light which is reflected by the reflecting mirror towards the expected eye position. Consequently, a beneficial effect is obtained in that it is possible to achieve a display device which is capable of displaying a fictive image by reflection of diffracted light by a reflecting mirror, while also increasing the transmissivity of the reflecting mirror. By making this ratio not more than 100 times, it is possible to make the ratio between the transmitted light and reflected light of the diffracted light less than a hundred percent. Accordingly, a beneficial effect is obtained in that the amount of unwanted transmitted light of the diffracted light is suppressed, without reducing the brightness of the fictive image generated by the reflected light. Therefore, even when the user's or another user's eye is situated in a position outside the expected eye position, a beneficial effect is obtained in that it is possible to reduce the amount of light incident on the eye and to reduce discomfort to the user. Moreover, a beneficial effect is also obtained in that the output of the light source can be reduced and a more compact size and power savings can be achieved.

Furthermore, in the display device described above, desirably, a horizontal direction in a state where the user wearing the wearing section on a head stands upright is defined as a first direction, a direction perpendicular to the first direction is defined as a second direction, an incidence angle of the diffracted light which is incident on the reflecting mirror is defined as a first incidence angle, a reflection angle of the diffracted light which is reflected by the reflecting mirror is defined as a first reflection angle, an incidence angle in the first direction of the diffracted light which is incident on the reflecting mirror is defined as a second incidence angle, an incidence angle in the second direction of the diffracted light which is incident on the reflecting mirror is defined as a third incidence angle, and the spatial modulation element is arranged with respect to the reflecting mirror so that, in a reflecting region of the reflecting mirror, a region where the first incidence angle is larger than the first reflection angle is broader than a region where the first incidence angle is smaller than the first reflection angle, and so that a region where the second incidence angle is larger than the third incidence angle is broader than a region where the second incidence angle is smaller than the third incidence angle.

According to this composition, a horizontal direction in a state where the user wearing the wearing section on a head stands upright is defined as a first direction. A direction perpendicular to the first direction is defined as a second direction. An incidence angle of the diffracted light which is incident on the reflecting mirror is defined as a first incidence angle. A reflection angle of the diffracted light which is reflected by the reflecting mirror is defined as a first reflection angle. An incidence angle in the first direction of the diffracted light which is incident on the reflecting mirror is defined as a second incidence angle. An incidence angle in the second direction of the diffracted light which is incident on the reflecting mirror is defined as a third incidence angle. The spatial modulation element is arranged with respect to the reflecting mirror so that, in a reflecting region of the reflecting mirror, a region where the first incidence angle is larger than the first reflection angle is broader than a region where the first incidence angle is smaller than the first reflection angle, and so that a region where the second incidence angle is larger than the third incidence angle is broader than a region where the second incidence angle is smaller than the third incidence angle.

Consequently, a beneficial effect is obtained in that the left and right positions of the fictive image can be brought close to a position in front of the user. A beneficial effect is obtained in that the position of the spatial modulation element in the wearing section can be situated towards the front of the wearing section, as a result of which it is possible to achieve a shape of the wearing section in which the portion of the wearing section close to the reflecting mirror on the front side has greater height than the ear portion of the wearing section. Moreover, a beneficial effect is obtained in that it is possible to achieve a display device in which diffracted light directed towards the reflecting mirror from the spatial modulation element is not shielded by a portion of the user's face in the periphery of the eye, which is situated between the spatial modulation element and the reflecting mirror.

Furthermore, desirably, the display device described above further includes a lens section which is arranged in front of the expected eye position in a state where the wearing section is worn on the user's head, wherein the reflecting mirror includes a Fresnel lens which is bonded by an adhesive to a surface of the lens section on a side of the expected eye position, the lens section and the Fresnel lens which are bonded by the adhesive have, as interfaces, in order from the side of the expected eye position to an opposite side, a surface on the expected eye position side, a Fresnel lens surface, a bonding surface and a surface on the opposite side, and a material forming the Fresnel lens and a material forming the adhesive are selected so that a refractive index of the Fresnel lens between the surface on the expected eye position side and the Fresnel lens surface is substantially equal to a refractive index of the adhesive between the Fresnel lens surface and the bonding surface.

According to this composition, the lens section is arranged in front of the expected eye position in a state where the wearing section is worn on the user's head. The Fresnel lens is bonded to the surface of the lens section on the side of the expected eye position by an adhesive. The lens section and the Fresnel lens which are bonded by the adhesive have, as interfaces, in order from the side of the expected eye position to an opposite side, a surface on the expected eye position side, a Fresnel lens surface, a bonding surface and a surface on the opposite side. A material forming the Fresnel lens and a material forming the adhesive are selected so that a refractive index of the Fresnel lens between the surface on the expected eye position side and the Fresnel lens surface is substantially equal to a refractive index of the adhesive between the Fresnel lens surface and the bonding surface.

Therefore, a beneficial effect is obtained in that the shape and inclination of the lens section are close to conventional glasses which do not have a function for displaying a fictive image. A beneficial effect is obtained in that the shape of the reflecting mirror can be made thin and the incidence angle and the reflection angle can be designed freely. A beneficial effect is obtained in that it is possible to achieve a display device in which the diffracted light from the spatial modulation element of the wearing section is reflected just as if arriving at the user from the front, while suppressing distortion of the scene outside by allowing the transmitted light of the outside world to be transmitted straight. Furthermore, since the reflecting mirror includes a Fresnel lens which is not a diffracting element, a beneficial effect is obtained in that it is possible to avoid the effects of unwanted diffracted light or the effects of variation in the diffraction angle.

Furthermore, in the display device described above, desirably, the illumination optical system causes the illumination light to converge on the expected eye position.

According to this composition the illumination optical system causes the illumination light to converge on the expected eye position. Therefore, the diffraction angle required in the spatial modulation element can be reduced. Consequently, a beneficial effect is obtained in that it is possible to achieve a display device which displays a fictive image having a wider angle of view and a larger screen size. Furthermore, a beneficial effect is obtained in that it is possible to achieve a simple illumination optical system and to achieve a compact size, with the split of parallel light not being needed as in the conventional example. Moreover, as a result of adopting illumination light which converges on the expected eye position, a beneficial effect is obtained in that the image quality and the angle of view can be increased focusing at the expected eye position. Furthermore, since unwanted light outside the position of the expected eye position is reduced and the required amount of light is reduced, beneficial effects are obtained in that the size can be made more compact, higher brightness is achieved, and power savings can be made.

Furthermore, in the display device described above, desirably, the expected eye position is a position of a center of the eye of the user, a width of the spatial modulation element is defined as W1, a width of the illumination light at a position of a pupil of the user is defined as W2, a width of a diffraction range at the position of the pupil, which is dependent on an upper limit of a diffraction angle which is determined in accordance with a fineness of stripes in the diffraction pattern, is defined as W3, and a degree of convergence of the illumination light by the illumination optical system and the fineness of the spatial modulation element are predetermined so that W3≦W2≦W1 is satisfied.

According to this composition, the expected eye position is a position of a center of the eye of the user. The width of the spatial modulation element is defined as W1. The width of the illumination light at the position of a pupil of the user is defined as W2. The width of a diffraction range at the position of the pupil, which is dependent on an upper limit of a diffraction angle which is determined in accordance with a fineness of stripes in the diffraction pattern, is defined as W3. A degree of convergence of the illumination light by the illumination optical system and the fineness of the spatial modulation element are predetermined so that W3≦W2≦W1 is satisfied. Consequently, a beneficial effect is obtained in that it is possible to achieve a display device which displays a fictive image having a wider angle of view. Furthermore, a beneficial effect is obtained in that a larger spatial modulation element can be used. Moreover, a beneficial effect is obtained in that a fictive image can be continuously viewed even when the eyeball is rotated. A beneficial effect is also obtained in that it is also possible to improve the image quality at the point of regard (central visual field) than that at the peripheral visual field.

Furthermore, in the display device described above, desirably, the illumination optical system causes the illumination light to converge so that a center of convergence is situated at a position on a line segment from a pupil center at the position of the pupil to an eyeball center of the eye of the user.

According to this composition, the illumination optical system causes the illumination light to converge so that a center of convergence is situated at a position on a line segment from a pupil center at the position of the pupil to an eyeball center of the eye of the user. In other words, the expected eye position is situated on a line segment connecting the pupil center and the eyeball center. According to this composition, a beneficial effect is obtained in that it is possible to achieve a display device which gives preference to the display characteristics when the pupil is located at the front with respect to the user's head, in a case where the center of convergence of the illumination light is situated at the pupil center. A beneficial effect is obtained in that it is possible to achieve a display device which gives preference to the display characteristics when a fictive image is viewed by rotating the eye, in a case where the center of convergence of the illumination light is situated at the eyeball center. By setting the center of convergence to a position on a line segment from the pupil center to the eyeball center, a beneficial effect is obtained in that the balance between these display characteristics can be specified freely.

Furthermore, in the display device described above, desirably, a horizontal direction in a state where the user wearing the wearing section on a head stands upright is defined as a first direction, a direction perpendicular to the first direction is defined as a second direction, and the illumination optical system causes the illumination light to converge so that a degree of convergence of the illumination light differs in the first direction and the second direction, and so that a position of a center of convergence of the illumination light in the first direction is closer to the eyeball center than the position of the center of convergence in the second direction.

According to this composition, a horizontal direction in a state where the user wearing the wearing section on a head stands upright is defined as a first direction. A direction perpendicular to the first direction is defined as a second direction. The illumination optical system causes the illumination light to converge so that a degree of convergence of the illumination light differs in the first direction and the second direction, and so that a position of a center of convergence of the illumination light in the first direction is closer to the eyeball center than the position of the center of convergence in the second direction. According to this composition, a beneficial effect is obtained in that it is possible to achieve a display device which is suited to a fictive image of horizontally long.

Furthermore, in the display device described above, desirably, the light source outputs the laser light having a spectral width of not less than 0.1 nm.

According to this composition, the light source outputs laser light having a spectral width of not less than 0.1 nm. Since the illumination light is caused to converge by the illumination optical system, it is possible to reduce the diffraction angle required in the spatial modulation element. As a result of this, a beneficial effect is obtained in that no problem occurs even when using a light source having a broader spectral width. Therefore, a beneficial effect is obtained in that the light source can be made compact in size and the cost thereof can be reduced.

Furthermore, in the display device described above, desirably, a spectral width of the laser light output from the light source is broader in a case of pulse lighting than in a case of constant lighting, the light source outputs laser light of three colors of red, green and blue by time division, as the laser light, and the spatial modulation element displays a different diffraction pattern for each of the colors, in synchronization with the output of the laser light of the three colors.

According to this composition, a spectral width of the laser light output from the light source is broader in a case of pulse lighting than in a case of constant lighting. The light source outputs laser light of three colors of red, green and blue by time division, as the laser light. The spatial modulation element displays a different diffraction pattern for each of the colors, in synchronization with the output of the laser light of the three colors. Since the illumination light is converged by the illumination optical system, it is possible to reduce the diffraction angle required in the spatial modulation element. Consequently, it is possible to use laser light having a broader spectral width. As a result of this, a beneficial effect is obtained in that it is possible to achieve a color display by outputting the laser light of three colors by time division driving. Moreover, a beneficial effect is obtained in that the light source used can be made compact in size and the cost thereof can be reduced.

Furthermore, desirably, the display device described above further includes an acquisition unit which acquires at least one of a temperature of the light source, a lighting time of the light source, an intensity of the laser light output from the light source and a diffraction angle of the diffracted light diffracted by the spatial modulation element, as diffraction angle information, wherein the spatial modulation element changes the diffraction pattern to be displayed using the diffraction angle information acquired by the acquisition unit.

According to this composition, the acquisition unit acquires at least one of the temperature of the light source, the lighting time of the light source, the intensity of the laser light output from the light source and the diffraction angle of the diffracted light by the spatial modulation element, as the diffraction angle information. The spatial modulation element changes the diffraction pattern to be displayed using the diffraction angle information acquired by the acquisition unit. When the temperature of the light source rises and the wavelength of the laser light output from the light source changes, the diffraction angle of the diffracted light which is diffracted by the spatial modulation element changes. When the lighting time of the light source becomes long, the temperature of the light source rises, and the wavelength of the laser light output from the light source changes, the diffraction angle changes in a similar fashion. When the intensity of the laser light output from the light source increases, the temperature of the light source rises and the wavelength of the laser light output from the light source changes, the diffraction angle changes in a similar fashion. In response to this, the spatial modulation element changes the diffraction pattern to be displayed using the diffraction angle information acquired by the acquisition unit. Consequently, a beneficial effect is obtained in that it is possible to reduce deterioration of the image quality due to change in the diffraction angle caused by variation in the wavelength of the light source and the like. Since a response to change in the diffraction angle is made possible by changing the diffraction pattern, rather than adjusting the illumination optical system, a beneficial effect is obtained in that the illumination optical system can be made compact in size and simplified, the costs thereof can be reduced and long life-span thereof can be achieved. Moreover, a beneficial effect is also obtained in that it is possible to increase the environmental adaptability of the display device, such as the usable temperature range thereof.

Furthermore, desirably, the display device described above further includes a storage unit which stores a degree of myopia of the user, wherein the spatial modulation element displays the diffraction pattern by which a distance from the expected eye position to the fictive image becomes a distance corresponding to the degree of myopia.

According to this composition, the storage unit stores a degree of myopia of the user. The spatial modulation element displays a diffraction pattern by which a distance from the expected eye position to the fictive image becomes a distance corresponding to the degree of myopia. Consequently, a beneficial effect is obtained in that it is possible to respond to different degrees of myopia for each user with a simple illumination optical system.

Furthermore, since a response to the degree of myopia is provided by the diffraction pattern displayed on the spatial modulation element, rather than adjusting the illumination optical system, a beneficial effect is obtained in that it is possible to reduce the portion of the illumination optical system which is driven physically, a more compact size, simpler structure and lower costs of the illumination optical system can be achieved, and the failure rate can be reduced. Moreover, since the degree of myopia is stored in the storage unit, a beneficial effect is obtained in that it is possible to reduce the work involved in setting up the illumination optical system and the spatial modulation element for each user.

Furthermore, desirably, the display device described above further includes a receiving unit which receives the diffraction pattern which is transmitted by radio communication from an external device, wherein the spatial modulation element displays the diffraction pattern which is received by the receiving unit.

According to this composition, the receiving unit receives the diffraction pattern which is transmitted by radio communication from an external device. The spatial modulation element displays the diffraction pattern which is received by the receiving unit. According to this composition, the calculation of the diffraction pattern is not carried out in the main body of the display device. As a result of this, a beneficial effect is obtained in that it is possible to reduce the size and the weight of the display device. Furthermore, a beneficial effect is also obtained in that it is possible to reduce the generation of heat by a member which carries out the calculation of the diffraction pattern.

Furthermore, desirably, the display device described above further includes a calculation unit which calculates a diffraction pattern corresponding to the fictive image, wherein the spatial modulation element displays the diffraction pattern which is calculated by the calculation unit.

According to this composition, the calculation unit calculates a diffraction pattern corresponding to the fictive image. The spatial modulation element displays the diffraction pattern which is calculated by the calculation unit. Therefore, it is possible to display the fictive image appropriately to the user.

Furthermore, desirably, the display device described above further includes: a lens section which is arranged in front of the expected eye position in a state where the wearing section is worn on the user's head; and a second spatial modulation element which is provided separately from the spatial modulation element, wherein the spatial modulation element and the second spatial modulation element are arranged in the lens section, and the second spatial modulation element displays a diffraction pattern which cancels out phase modulation, in the spatial modulation element, to transmitted light from scene outside.

According to this composition, the lens section is arranged in front of the expected eye position in a state where the wearing section is worn on the user's head. The second spatial modulation element is provided separately from the spatial modulation element. The spatial modulation element and the second spatial modulation element are arranged in the lens section. The second spatial modulation element displays a diffraction pattern which cancels out phase modulation, in the spatial modulation element, to transmitted light from scene outside. Consequently, it is possible to impart a fictive image display function to the lens section. Therefore, since it is not necessary to provide a member, such as a reflecting mirror, which directs the diffracted light from the spatial modulation element towards the expected eye position, a beneficial effect is obtained in that the display device can be made compact in size and can be simplified. Moreover, since the spatial modulation element is not arranged in the wearing section, a beneficial effect is obtained in that the wearing section can be made compact in size. Furthermore, since the distance from the eye to the spatial modulation element is shortened, a beneficial effect is obtained in that a wider angle of view and larger screen size can be achieved. Moreover, a beneficial effect is obtained in that it is possible to diminish distortion of the scene outside by the second spatial modulation element.

According to the display device of the present invention, it is possible to provide a display device which is capable of achieving both a compact size of the device and a large screen size (a wide angle of view) by distant display of the fictive image which is displayed to the user.

### INDUSTRIAL APPLICABILITY

The display device according to the present invention is useful as a display device, such as an HMD, in which a spatial modulation element, which diffracts illumination light that is laser light by displaying a diffraction pattern, is arranged close to the eye and the diffracted light from the spatial modulation element reaches the expected eye position. Furthermore, the display device can also be applied to a display system, a display method, a display device design method, and the like.

1. A display device, comprising:
a light source which outputs laser light;
an illumination optical system which emits the laser light as illumination light;
a spatial modulation element which diffracts the illumination light by displaying a diffraction pattern; and
a wearing section for wearing on a user's head, wherein
a positional relationship between the spatial modulation element and an expected eye position, which is expected to be a position of an eye of the user, is fixed in a state where the wearing section is worn on the user's head,
the spatial modulation element displays, as the diffraction pattern, a diffraction pattern by which a fictive image is displayed to the user due to diffracted light, which has been diffracted by the diffraction pattern, reaching the expected eye position,
the display device further comprises a reflecting mirror which reflects the diffracted light, which has been diffracted by the spatial modulation element, towards the expected eye position,
the reflecting mirror is arranged in front of the expected eye position in a state where the wearing section is worn on the user's head,
the spatial modulation element is a reflective element,
the spatial modulation element is arranged with respect to the illumination optical system so that the illumination light emitted from the illumination optical system is incident obliquely on a surface of the spatial modulation element, and
the spatial modulation element displays the diffraction pattern by which an angle between a display plane of the fictive image displayed to the user and an optical axis of the diffracted light after reflected by the reflecting mirror is closer to perpendicular compared to an angle between a surface of the spatial modulation element and an optical axis of the diffracted light before reflected by the reflecting mirror.

2. The display device according to claim 1, wherein
the spatial modulation element is arranged at a position in which an optical axis distance from the expected eye position to the spatial modulation element is not more than 10 cm in a state where the wearing section is worn on the user's head, and
the spatial modulation element displays the diffraction pattern which causes the fictive image to be displayed at a further distance than a distance from the expected eye position to a virtual image of the spatial modulation element.

3. The display device according to claim 2, wherein
the spatial modulation element is arranged at a position in which a distance from the expected eye position to a virtual image of the spatial modulation element is shorter than a distance of distinct vision of 25 cm, and
the spatial modulation element displays the diffraction pattern by which a distance from the expected eye position to the fictive image is longer than the distance of distinct vision.

4. The display device according to claim 1, wherein
the light source, the illumination optical system and the spatial modulation element are arranged in a void formed inside the wearing section.

5. (canceled)

6. The display device according to claim 4, wherein
a transmissive aperture is formed in the wearing section so that the diffracted light diffracted by the spatial modulation element reaches the expected eye position, and
the periphery of the transmissive aperture in the wearing section shields light so that unwanted diffracted light, which is generated by incidence of external light other than the illumination light on the spatial modulation element, does not reach the expected eye position.

7. The display device according to claim 1, wherein an amount of transmitted light of the diffracted light which is transmitted by the reflecting mirror and output in an opposite direction to the expected eye position is not more than 100 times larger than an amount of reflected light of the diffracted light which is reflected by the reflecting mirror towards the expected eye position.

8. The display device according to claim 1, wherein
a horizontal direction in a state where the user wearing the wearing section on a head stands upright is defined as a first direction,
a direction perpendicular to the first direction is defined as a second direction,
an incidence angle of the diffracted light which is incident on the reflecting mirror is defined as a first incidence angle,
a reflection angle of the diffracted light which is reflected by the reflecting mirror is defined as a first reflection angle,
an incidence angle in the first direction of the diffracted light which is incident on the reflecting mirror is defined as a second incidence angle,
an incidence angle in the second direction of the diffracted light which is incident on the reflecting mirror is defined as a third incidence angle, and
the spatial modulation element is arranged with respect to the reflecting mirror so that, in a reflecting region of the reflecting mirror, a region where the first incidence angle is larger than the first reflection angle is broader than a region where the first incidence angle is smaller than the first reflection angle, and so that a region where the second incidence angle is larger than the third incidence angle is broader than a region where the second incidence angle is smaller than the third incidence angle.

9. The display device according to claim 1, further comprising a lens section which is arranged in front of the expected eye position in a state where the wearing section is worn on the user's head, wherein
the reflecting mirror includes a Fresnel lens which is bonded by an adhesive to a surface of the lens section on a side of the expected eye position,
the lens section and the Fresnel lens which are bonded by the adhesive have, as interfaces, in order from the side of the expected eye position to an opposite side, a surface on the expected eye position side, a Fresnel lens surface, a bonding surface and a surface on the opposite side, and
a material forming the Fresnel lens and a material forming the adhesive are selected so that a refractive index of the Fresnel lens between the surface on the expected eye position side and the Fresnel lens surface is substantially equal to a refractive index of the adhesive between the Fresnel lens surface and the bonding surface.

10. The display device according to claim 1, wherein the illumination optical system causes the illumination light to converge on the expected eye position.

11. The display device according to claim 10, wherein
the expected eye position is a position of a center of the eye of the user,
a width of the spatial modulation element is defined as W1,
a width of the illumination light at a position of a pupil of the user is defined as W2,
a width of a diffraction range at the position of the pupil, which is dependent on an upper limit of a diffraction angle which is determined in accordance with a fineness of stripes in the diffraction pattern, is defined as W3, and
a degree of convergence of the illumination light by the illumination optical system and the fineness of the spatial modulation element are predetermined so that W3≦W2≦W1 is satisfied.

12. The display device according to claim 10, wherein the illumination optical system causes the illumination light to converge so that a center of convergence is situated at a position on a line segment from a pupil center at the position of the pupil to an eyeball center of the eye of the user.

13. The display device according to claim 12, wherein
a horizontal direction in a state where the user wearing the wearing section on a head stands upright is defined as a first direction,
a direction perpendicular to the first direction is defined as a second direction, and
the illumination optical system causes the illumination light to converge so that a degree of convergence of the illumination light differs in the first direction and the second direction, and so that a position of a center of convergence of the illumination light in the first direction is closer to the eyeball center than the position of the center of convergence in the second direction.

14. The display device according to claim 10, wherein the light source outputs the laser light having a spectral width of not less than 0.1 nm.

15. The display device according to claim 10, wherein
a spectral width of the laser light output from the light source is broader in a case of pulse lighting than in a case of constant lighting,
the light source outputs laser light of three colors of red, green and blue by time division, as the laser light, and
the spatial modulation element displays a different diffraction pattern for each of the colors, in synchronization with the output of the laser light of the three colors.

16. The display device according to claim 1, further comprising an acquisition unit which acquires at least one of a temperature of the light source, a lighting time of the light source, an intensity of the laser light output from the light source and a diffraction angle of the diffracted light diffracted by the spatial modulation element, as diffraction angle information, wherein
the spatial modulation element changes the diffraction pattern to be displayed using the diffraction angle information acquired by the acquisition unit.

17. The display device according to claim 1, further comprising a storage unit which stores a degree of myopia of the user, wherein
the spatial modulation element displays the diffraction pattern by which a distance from the expected eye position to the fictive image becomes a distance corresponding to the degree of myopia.

18. The display device according to claim 1, further comprising a receiving unit which receives the diffraction pattern which is transmitted by radio communication from an external device, wherein
the spatial modulation element displays the diffraction pattern which is received by the receiving unit.

19. The display device according to claim 1, further comprising a calculation unit which calculates a diffraction pattern corresponding to the fictive image, wherein
the spatial modulation element displays the diffraction pattern which is calculated by the calculation unit.

20. The display device according to claim 1, further comprising:
a lens section which is arranged in front of the expected eye position in a state where the wearing section is worn on the user's head; and
a second spatial modulation element which is provided separately from the spatial modulation element, wherein
the spatial modulation element and the second spatial modulation element are arranged in the lens section, and
the second spatial modulation element displays a diffraction pattern which cancels out phase modulation, in the spatial modulation element, to transmitted light from scene outside.
